(19) United States
(12) Patent Application Publication
(10) Pub. No.: US 2024/0198583 A1
(43) Pub. Date: Jun. 20, 2024

(54) SYSTEMS AND METHODS FOR HIGH THROUGHPUT VOLUMETRIC THREE-DIMENSIONAL (3D) PRINTING

(71) Applicant: QUADRATIC 3D, INC., CHARLESTOWN, MA (US)

(72) Inventors: EMILY M. ARNDT, AKRON, OH (US); SAMUEL N. SANDERS, ARLINGTON, MA (US)

(21) Appl. No.: 18/414,305

(22) Filed: Jan. 16, 2024

Related U.S. Application Data
(63) Continuation of application No. PCT/US2022/037495, filed on Jul. 18, 2022.
Application No. PCT/US2022/037495 is a continuation-in-part of application No. PCT/US2021/024878, filed on Mar. 30, 2021.
(60) Provisional application No. 63/226,594, filed on Jul. 28, 2021.
(60) Provisional application No. 63/228,356, filed on Aug. 2, 2021.
(60) Provisional application No. 63/223,112, filed on Jul. 19, 2021.
(60) Provisional application No. 63/226,605, filed on Jul. 28, 2021.
(60) Provisional application No. 63/239,345, filed on Aug. 31, 2021.
(60) Provisional application No. 63/003,078, filed on Mar. 31, 2020.

(51) Int. Cl. B29C 64/129; B29C 64/255; B29C 64/264; B29C 64/321; B29C 64/357; B33Y 10/00; B33Y 30/00; B33Y 40/00; B33Y 70/00

(52) U.S. Cl. CPC B29C 64/129; B29C 64/255; B29C 64/264; B29C 64/321; B29C 64/357; B33Y 10/00; B33Y 30/00; B33Y 40/00; B33Y 70/00

(57) ABSTRACT

A method includes: providing a volume of a photopolymerizable liquid in a container including one or more printing zones, wherein a printing zone is configured to facilitate directing at least two excitation light projections into the printing zone to form a three-dimensional printed object within the volume of photopolymerizable liquid in the printing zone, directing the at least two excitation light projections into the printing zone to selectively photopolymerize the photopolymerizable liquid at one or more selected locations in the printing zone, and discharging the photopolymerizable liquid and any printed objects contained therein out of the container. Other methods and systems for printing one or more three-dimensional objects are also disclosed.

### CROSS-REFERENCE TO RELATED APPLICATIONS

This application is a continuation of International Application No. PCT/US2022/037495 filed 18 Jul. 2022, which International Application claims priority to U.S. Provisional Patent Application No. 63/226,594 filed 28 Jul. 2021; U.S. Provisional Patent Application No. 63/228,356 filed 2 Aug. 2021; U.S. Provisional Patent Application No. 63/223,112 filed on 19 Jul. 2021; U.S. Provisional Patent Application No. 63/226,605 filed on 28 Jul. 2021; and U.S. Provisional Patent Application No. 63/239,345 filed on 31 Aug. 2021; International Application No. PCT/US2022/037495 is also a continuation-in-part application of International Application No. PCT/US2021/024878, filed 30 Mar. 2021, which International Application claims priority to U.S. Application No. 63/003,078 filed 31 Mar. 2020. Each of the foregoing International Applications and U.S. Provisional Patent Applications is hereby incorporated herein by reference in its entirety for all purposes.

### TECHNICAL FIELD OF THE INVENTION

The present invention relates to the technical field of three-dimensional printing.

### BRIEF SUMMARY OF THE INVENTION

The present invention includes systems and methods for printing one or more three-dimensional objects.

In accordance with one aspect of the present invention, there is provided a system for printing one or more three-dimensional objects, the system comprising: a container configured to contain a volume of a photopolymerizable liquid, the container including an exit port, the exit port facilitating discharge of photopolymerizable liquid and one or more of any printed three-dimensional objects contained therein from the container, the container including one or more printing zones, wherein a printing zone is configured to facilitate directing at least two excitation light projections into the printing zone to form a three-dimensional printed object within the volume of photopolymerizable liquid in the printing zone, and a dispensing system capable of introducing photopolymerizable liquid into the container.

The container can further include an entry port positioned relative to the exit port to provide a flow path for photopolymerizable liquid from the entry port to the exit port that can facilitate transport of any printed part contained therein from the printing zone to the exit port for discharge from the container. The entry port can be adapted for connection to the dispensing system.

The container can be an open container. For example, the container can have an opening above the volume-containing portion of the container, e.g., a complete or partially open top side of the container and/or one or more openings in a side wall of the container. While an open container can facilitate introduction of photopolymerizable liquid through an open portion thereof, inclusion of an entry port in an open container may be desirable for use in introducing photopolymerizable liquid to the container. For example, dispensing the photopolymerizable liquid through an entry port may permit better control of the amount and/or rate of addition to the container. Other configurations may also be determined to be useful.

The container can be a closable container. Examples of closable containers include, for example, but are not limited to, a container with a removable cover or a hinged cover. A removable or hinged cover can be a full or partial removable cover or a full or partial hinged cover.

The container can be a closed container.

Preferably the entry port, if included, and/or the exit port are controllably openable and closable.

The system can further include one or more optical systems positioned or positionable to direct at least two excitation light projections into the printing zone.

The system can further include a reservoir for containing a supply of a photopolymerizable liquid, the reservoir having a reservoir outlet and a reservoir inlet and optionally a pressure-exerting device (e.g., a pump, a piston, or the like) in connection with the reservoir outlet for feeding an amount of the photopolymerizable liquid from the reservoir to the dispensing system. Optionally the reservoir can be part of the dispensing system.

The system can further include a separator unit in connection with the exit port of the container for receiving the unpolymerized photopolymerizable liquid and one or more printed three-dimensional objects discharged from the container. The separator unit is preferably capable of separating any printed three-dimensional objects from unpolymerized photopolymerizable liquid included in the discharged contents. A separator unit can include a first discharge port for discharging any separated printed objects from the separator unit. A separator unit can further include a second discharge port for discharging the separated unpolymerized photopolymerizable liquid from the separator unit.

In accordance with another aspect of the present invention, there is provided a system for printing one or more three-dimensional objects, the system comprising: a closed container including an entry port and an exit port, the entry port and the exit port being connected by a channel therebetween, the closed container including one or more printing zones, wherein a printing zone comprises one or more optically transparent regions to facilitate directing at least two excitation light projections into the printing zone through the one or more optically transparent regions to form a three-dimensional printed object within a volume of photopolymerizable liquid in the printing zone, and a pressure-exerting device (e.g., a pump, a piston, or the like) in connection with the entry port of the closed container and adapted for connection to a source of the photopolymerizable liquid, the pressure-exerting device being capable of pumping an amount of the photopolymerizable liquid into the closed container through the entry port.

The system can further include one or more optical systems positioned or positionable to direct at least two excitation light projections into the printing zone.

Preferably the system is capable of being leak tight to prevent undesired leakage of the photopolymerizable liquid. For example, under leak tight conditions, photopolymerizable liquid is retained without loss from leakage in the closed container and without leakage of photopolymerizable liquid at each connection and port when pressurized due to pumping of the photopolymerizable liquid or otherwise.

Optionally the system is capable of being maintained in an inert atmosphere and wherein each connection and port is airtight.

Preferably the system is capable of being light tight except for the printing zone to reduce unwanted photopolymerization and any inspection unit or zone that may utilize light as part of an inspection/characterization technique.

In accordance with another aspect of the present invention, there is provided a system for printing one or more three-dimensional objects, the system comprising: a reservoir for containing a supply of a photopolymerizable liquid, the reservoir having a reservoir outlet and a reservoir inlet, a pressure-exerting device (e.g., a pump, a piston, or the like) in connection with the reservoir outlet for pumping an amount of the photopolymerizable liquid from the reservoir into a closed container through an entry port in the closed container, the closed container including the entry port and an exit port, the entry port and the exit port being connected by a channel therebetween, the closed container including one or more printing zones, a printing zone comprising one or more optically transparent regions to facilitate directing at least two excitation light projections into the printing zone through the one or more optically transparent regions to form a three-dimensional printed object from the photopolymerizable liquid in the printing zone, and a separator unit in connection with the exit port of the closed container for receiving contents discharged from the closed container, the separator unit being capable of separating any printed objects from unpolymerized photopolymerizable liquid included in the discharged contents, the separator unit including a first discharge port for discharging any separated printed objects from the separator unit and a second discharge port for discharging the separated unpolymerized photopolymerizable liquid from the separator unit.

The system can further include one or more optical systems positioned or positionable to direct at least two excitation light projections into the printing zone.

Preferably the system is capable of being leak tight to prevent undesired leakage of the photopolymerizable liquid. For example, under leak tight conditions, photopolymerizable liquid is retained without loss from leakage in the closed container and without leakage of photopolymerizable liquid at each connection and port when pressurized due to pumping of the photopolymerizable liquid or otherwise.

Optionally the system is capable of being maintained in an inert atmosphere and each of the connections and port are airtight.

Preferably the system is capable of being light tight except for the printing zone to reduce unwanted photopolymerization and any inspection unit or zone that may utilize light as part of an inspection/characterization technique.

In accordance with yet a further aspect of the present invention, there is provided a method of printing one or more three-dimensional objects, the method comprising: providing a volume of a photopolymerizable liquid in a container configured to contain a volume of a photopolymerizable liquid, the container including an exit port, the exit port facilitating discharge of photopolymerizable liquid and one or more of any printed three-dimensional objects contained therein from the container, the container including one or more printing zones, wherein a printing zone is configured to facilitate directing at least two excitation light projections into the printing zone to form a three-dimensional printed object within the volume of photopolymerizable liquid in the printing zone, directing the at least two excitation light projections into the printing zone to selectively photopolymerize the photopolymerizable liquid at one or more selected locations in the printing zone, and discharging the photopolymerizable liquid and any printed objects contained therein out of the container.

The system can further include one or more optical systems positioned or positionable to direct at least two excitation light projections into the printing zone.

The method can further include separating any printed objects from unpolymerized photopolymerizable liquid included in the discharged contents.

Optionally, the method further comprises recycling the separated unpolymerized photopolymerizable liquid from the discharged contents.

Optionally the method is carried out in an inert atmosphere.

Preferably the photopolymerizable liquid included in the container displays non-Newtonian rheological behavior and the at least two excitation light projections are selectively directed into the printing zone to selectively photopolymerize the photopolymerizable liquid at one or more selected locations in the printing zone to form a printed object without support structures, wherein the printed object remains at a fixed position or is minimally displaced in the unpolymerized photopolymerizable liquid during formation.

In accordance with a further aspect of the present invention, there is provided a method of printing one or more three-dimensional objects, the method comprising: providing a volume of a photopolymerizable liquid in a container including an entry port and an exit port, the entry port facilitating introduction of photopolymerizable liquid into the container and the exit port facilitating passage of unpolymerized photopolymerizable liquid and one or more printed three-dimensional object from the container, the container including one or more printing zones, wherein a printing zone is configured to facilitate directing at least two excitation light projections into the printing zone to form a three-dimensional printed object within a volume of photopolymerizable liquid in the printing zone, directing the at least two excitation light projections into the printing zone to selectively photopolymerize the photopolymerizable liquid in the printing zone, and discharging the photopolymerizable liquid and any printed objects contained therein out of the container.

The method can further include separating any printed objects from unpolymerized photopolymerizable liquid included in the discharged contents.

Optionally, the method further comprises recycling the separated unpolymerized photopolymerizable liquid from the discharged contents.

Optionally the method is carried out in an inert atmosphere.

Preferably the photopolymerizable liquid included in the container displays non-Newtonian rheological behavior and the at least two excitation light projections are selectively directed into the printing zone to selectively photopolymerize the photopolymerizable liquid at one or more selected locations in the printing zone to form a printed object without support structures, wherein the printed object remains at a fixed position or is minimally displaced in the unpolymerized photopolymerizable liquid during formation.

In accordance with a still further aspect of the present invention, there is provided a method of printing one or more three-dimensional objects, the method comprising: providing a volume of a photopolymerizable liquid in a closed container including an entry port and an exit port, the entry port and the exit port being connected by a channel therebetween, the container including one or more printing zones comprising one or more optically transparent regions to facilitate irradiating at least two excitation light projections into a printing zone through the one or more optically transparent regions, directing the at least two excitation light projections through the one or more optically transparent regions into the printing zone to selectively photopolymerize the photopolymerizable liquid at one or more locations in the printing zone, and applying pressure to the contents of the closed container and/or pumping additional photopolymerizable liquid into the closed container through the entry port to at least transport the printed object out of the printing zone toward the exit port, thereby discharging at least a portion of contents of the closed container out of the closed container through the exit port.

Preferably the photopolymerizable liquid included in the container displays non-Newtonian rheological behavior and the at least two excitation light projections are selectively directed into the printing zone to selectively photopolymerize the photopolymerizable liquid at one or more selected locations in the printing zone to form a printed object without support structures, wherein the printed object remains at a fixed position or is minimally displaced in the unpolymerized photopolymerizable liquid during formation.

The method can further include separating any printed objects from unpolymerized photopolymerizable liquid included in the discharged contents.

Optionally, the method further comprises recycling the separated unpolymerized photopolymerizable liquid from the discharged contents.

Optionally the method is carried out in an inert atmosphere.

In accordance with yet another aspect of the present invention, there is provided a system for printing one or more three-dimensional objects, the system comprising: a container including an entry port and an exit port, the entry port and the exit port being connected by a flow path therebetween, the container including a printing zone, wherein the printing zone comprises at least one optically transparent region to facilitate directing an excitation light into the printing zone through the optically transparent region to form a three-dimensional printed object within a volume of photopolymerizable liquid in the printing zone, and a pressure-exerting device (e.g., a pump, a piston, or the like) in connection with the entry port of the container and adapted for connection to a source of the photopolymerizable liquid, the pressure-exerting device being capable of pumping an amount of the photopolymerizable liquid into the container through the entry port.

Preferably the excitation light comprises at least two excitation light projections.

The system can further include a separator unit in connection with the exit port of the container for receiving the discharged contents from the container, the separator unit for separating any printed objects from unpolymerized photopolymerizable liquid included in the discharged contents, the separator unit including a first discharge port for discharging any separated printed objects from the separator unit and a second discharge port for discharging the separated unpolymerized photopolymerizable liquid from the separator unit.

The system can further include a recirculation loop in connection with the second discharge port for recirculating the separated unpolymerized photopolymerizable liquid to the source.

The system can further include a reservoir for containing a supply of a photopolymerizable liquid, the reservoir having a reservoir outlet and a reservoir inlet.

The system can further include one or more optical systems positioned or positionable to irradiate excitation light, preferably comprising two excitation light projections, through the optically transparent region of a printing zone.

The system can further include a reservoir for containing a supply of a photopolymerizable liquid, the reservoir having a reservoir outlet and a reservoir inlet

In accordance with still another aspect of the present invention, there is provided a method of printing one or more three-dimensional objects, the method comprising: providing a volume of a photopolymerizable liquid in a container including an entry port and an exit port, the entry port and the exit port being connected by a flow path therebetween, the container including at least one printing zone comprising at least an optically transparent window to facilitate directing excitation light into a printing zone through the at least an optically transparent window, directing the excitation light through the at least an optically transparent window into the printing zone to selectively photopolymerize the photopolymerizable liquid in the printing zone without support structures to form a printed object, wherein the printed object remains at a fixed position or is minimally displaced in the unpolymerized photopolymerizable liquid during formation, and applying pressure to the contents of the container and/or pumping additional photopolymerizable liquid into the container through the entry port to at least transport the printed object out of the printing zone toward the exit port, thereby discharging at least a portion of contents of the container out of the container through the exit port.

Preferably the excitation light comprises at least two excitation light projections.

The method can further comprise separating any printed objects from unpolymerized photopolymerizable liquid included in the discharged contents.

The method can further comprise recirculating the discharged unpolymerized photopolymerizable liquid after separation of any printed objects to a reservoir

Preferably the photopolymerizable liquid displays non-Newtonian rheological behavior such that the object formed in the photopolymerizable liquid within the printing zone remains at a fixed position or is minimally displaced in the unpolymerized photopolymerizable liquid during formation, directing the excitation light through the at least an optically transparent window into the printing zone to selectively photopolymerize the photopolymerizable liquid in the printing zone without support structures to form a printed object, wherein the printed object remains at a fixed position or is minimally displaced in the unpolymerized photopolymerizable liquid during formation.

More preferably the photopolymerizable liquid comprises a photohardenable component and a photoswitchable photoinitiator, wherein the photoswitchable photoinitiator is activatable by exposure to light having a first wavelength and light having a second wavelength to induce a crosslinking or polymerization reaction in the photohardenable component, wherein the first and second wavelengths are different, wherein the photopolymerizable composition displays non-Newtonian rheological behavior. Optionally, the photopolymerizable liquid can further include a coinitiator (also referred to herein as a synergist) and/or a sensitizer. A sensitizer can create the excited state of the photoswitchable photoinitiator via absorbing light and transferring energy to the photoswitchable photoinitiator.

In the systems and methods in accordance with the present invention, the selection of wavelength(s) of the excitation light for the excitation light projections is preferably made taking into account the photopolymerizable liquid and hardening mechanism being used.

For example, for photopolymerizable liquids that are hardenable via a hardening mechanism that involves a single wavelength of excitation light, the wavelength of the two or more excitation light projections can be the same. Optionally in such case, at least one of the two or more excitation light projections can include a different wavelength light, for example for inhibiting undesired hardening of the photopolymerizable liquid.

In cases where a photopolymerizable liquid is hardenable via a hardening mechanism that involves more than one wavelength of excitation light, the wavelength of at least two of the two or more excitation light projections will be selected for projection excitation light with appropriate wavelengths for the hardening mechanism. Optionally an additional wavelength light can also be used to inhibit undesired hardening of the photopolymerizable liquid. For example, when the hardening mechanism involves a two wavelength mechanism, a third wavelength light can also be used to inhibit undesired hardening of the photopolymerizable liquid.

Systems and methods in accordance with the present invention can further include one or more control system for controlling at least one of: the selective projection of the at least two excitation light projections into one or more of the printing zones at one or more selected locations, dispensing the photopolymerizable liquid into the container, discharging unpolymerized photopolymerizable liquid and one or more printed three-dimensional objects from the container, and opening and closing the entry port and/or exit port.

Optical systems included in the systems and methods described herein are typically used in combination with a computer and software. Software can be used to coordinate generation of optical projections (e.g., point illuminations, line illuminations, a two-dimensional pattern, or a light sheet) from their respective optical projection system at each position along the projection direction of each so that the part is developed plane by plane. The planar face of an optical projection can be orthogonal to its projection direction into photopolymerizable liquid. When two optical projections are projected into the printing zone, the projection directions of the two projections are preferably orthogonal to each other. Selection of computer controls and software is within the skill of the person of ordinary skill in the relevant art. Other components can also optionally be included or used with the system.

Systems in accordance with the present invention can optionally further include a post-treatment unit or region configured for receiving the separated printed objects from the separator unit, if included, for carrying out one or more selected post-treatment steps.

Methods in accordance with the present invention can optionally further include a step comprising post-treating separated objects. Examples of post-treatments are described below.

Systems in accordance with the present invention can optionally further include one or more inspection units or zones (which may also be referred to herein as regions) that is preferably not light tight. An inspection unit can facilitate visualization and/or characterization (e.g., measurement, flaw-detection, and the like) of printed objects. An inspection unit or zone can be situated to permit inspection of printed parts after formation, e.g., prior to separation (if included), after separation (if included), and/or after post-treatment (if included). Optionally light may be projected into inspection zone for purposes of, e.g., visualization or measurement. Optionally ultrasound may be projected into an inspection zone for purposes of, e.g., visualization or measurement.

Methods in accordance with the present invention can optionally further include one or more inspection steps. An inspection step can be included in a method described herein to permit inspection of printed parts after formation, e.g., prior to a separating step (if included), after a separating step (if included), and/or after a post-treatment step (if included).

Preferred systems and methods in accordance with the present invention are particularly useful for printing three-dimensional (3D) objects from photopolymerizable liquids that demonstrate non-Newtonian behavior and which can be solidified at volumetric positions impinged upon by two or more excitation light projections to form a printed object without requiring the addition of support structures and with increased ease of separating from unpolymerized photopolymerizable liquid. Support structures are typically required by most 3D printing technologies involving vat polymerization technologies to stabilize the part during printing or to allow printing of thin or fragile overhanging portions of the part; after printing, post-processing is required to remove the support structures, which can damage or leave marks on the printed part. Avoiding addition of support structures would advantageously simplify post-processing of printed parts and improve part surface quality. Non-Newtonian behavior of the photopolymerizable liquid can additionally simplify separation of the part from unpolymerized polymerizable liquid because upon application of stress, the apparent viscosity of the non-Newtonian photopolymerizable liquid drops to a lower value (e.g., the steady shear viscosity) than the static value (e.g., zero shear viscosity or yield stress) allowing the unpolymerized polymerizable liquid to more easily flow off and separate from the part. Heating of the unpolymerized photopolymerizable liquid in addition to applying stress may further enhance the ability of the liquid to flow off and separate from the part.

Systems and methods in accordance with the present invention advantageously further do not require adhering the object being printed to a fixed substrate (e.g., build plate) at the beginning of the printing process avoiding a post-processing step of separating the printed object from the fixed substrate.

In systems and methods in accordance with aspects of the invention including at least two excitation light projections, optionally one or more of the two excitation light projections can comprise a light sheet, which may be constructed by means known in the art including, for example, but not limited to: Powell lens, galvanometer, polygon scanning mirror.

In systems and methods in accordance aspects of the invention including at least two excitation light projections, it can be preferred for at least two of the at least two excitation light projections to be perpendicular to each other.

Methods in accordance with the present invention may further include pretreating the photopolymerizable liquid prior to introduction into the container, for example, to remove bubbles and any suspended debris. Non-limiting examples of such pretreating include degassing, centrifugation, filtration. A pretreatment module or region can optionally further be included in a system described herein.

In accordance with another aspect of the present invention, there is provided a method of separating one or more three-dimensional (3D) objects from a volume of a non-Newtonian photopolymerizable liquid, for example, in which the object is formed, the method comprising lowering the apparent viscosity (e.g., steady shear viscosity) of the non-Newtonian photopolymerizable liquid including the one or more 3D objects to a value below the static value (e.g., zero shear viscosity or yield stress) such that the unhardened photopolymerizable liquid flow off or separates from the one or more 3D objects.

Preferably the apparent viscosity is lowered to a value below the static value by application of force or stress, e.g., by tapping, shaking, vibrating, sonicating. More preferably the photopolymerizable liquid including the one or more 3D objects is heated in addition to applying stress. The addition of heat can further enhance the ability of the liquid to flow off and/or separate from the part.

The foregoing, and other aspects and embodiments described herein and contemplated by this disclosure all constitute embodiments of the present invention.

It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention contemplated by this disclosure.

It is to be understood that both the foregoing general description and the following detailed description are exemplary and explanatory only and are not restrictive of the invention as claimed.

Other embodiments will be apparent to those skilled in the art from consideration of the description and drawings, from the claims, and from practice of the invention disclosed herein.

### BRIEF DESCRIPTION OF THE DRAWINGS

In the drawings,

FIG. 1 depicts a diagram of an example of a system in accordance with the present invention.

FIG. 2 depicts a diagram of an example of a system in accordance with the present invention.

FIG. 3 depicts a diagram of an example of a system in accordance with the present invention.

FIG. 4 depicts a diagram of an example of a system in accordance with the present invention.

FIG. 5 depicts a diagram of an example of a system in accordance with the present invention.

FIG. 6 depicts a diagram of an example of a system in accordance with the present invention.

The attached figures are simplified representations presented for purposes of illustration only; the actual structures may differ in numerous respects, particularly including the relative scale of the articles depicted and aspects thereof.

For a better understanding to the present invention, together with other advantages and capabilities thereof, reference is made to the following disclosure and appended claims in connection with the above-described drawings.

### DETAILED DESCRIPTION OF THE INVENTION

Various aspects and embodiments of the present inventions will be further described in the following detailed description.

The present invention relates to systems and methods for printing one or more three-dimensional objects.

In accordance with one aspect of the present invention, there is provided a system for printing one or more three-dimensional objects, the system comprising: a container configured to contain a volume of a photopolymerizable liquid, the container including an exit port, the exit port facilitating discharge of photopolymerizable liquid and one or more of any printed three-dimensional objects contained therein from the container, the container including one or more printing zones, wherein a printing zone is configured to facilitate directing at least two excitation light projections into the printing zone to form a three-dimensional printed object within the volume of photopolymerizable liquid in the printing zone, and a dispensing system capable of introducing photopolymerizable liquid into the container.

Preferably the printing zone includes one or more optically transparent regions to facilitate directing at least at least two excitation light projections into a printing zone through the one or more optically transparent regions.

The container can further include an entry port positioned relative to the exit port to provide a flow path for photopolymerizable liquid from the entry port to the exit port that can facilitate transport of any printed part contained therein from the printing zone to the exit port for discharge from the container. The entry port can be adapted for connection to the dispensing system for dispensing an amount of the photopolymerizable liquid into the container through entry port.

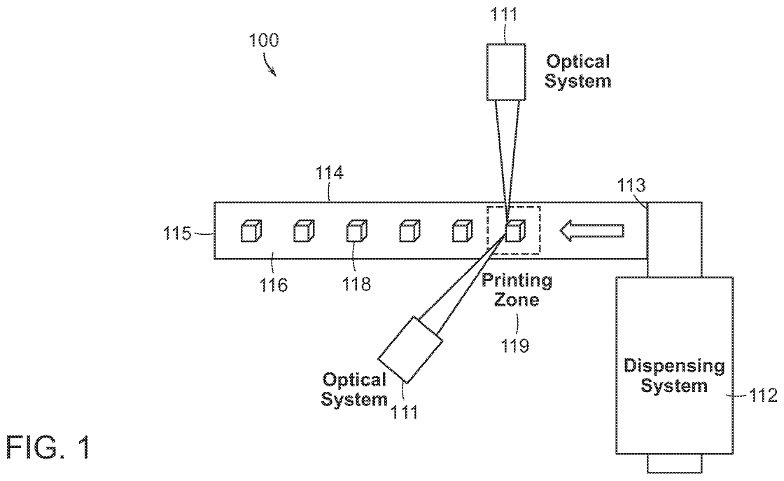

FIG. 1 depicts a diagram of an example of an embodiment of a system in accordance with an aspect of the present invention. The diagram depicts a system 100 including a dispensing system 112 in connection with the entry port 113 of a container 114. The dispensing system is adapted for connection to a source of photopolymerizable liquid (not shown). The container also includes an exit port 115. The entry port 113 and the exit port 115 are connected by a channel 116 therebetween. As depicted, the channel includes photopolymerizable liquid with a plurality of three-dimensional printed objects 118 therein, one of which is in the printing zone 119, the others spaced apart due to the location at which they are printed (e.g., due to translation of the optical printing system or translation of the container relative to the position of the optical printing system) or due to successive displacement from the printing zone toward the exit port by a series of separate additions of new amounts of photopolymerizable liquid dispensed into the container through the entry port from the dispensing system and discharge of printed objects from the exit port. The arrow depicted in FIG. 1 indicates the direction of the flow of the photopolymerizable liquid in the channel from the entry point where the liquid is introduced into the container to the exit port through which contents are discharge from the closed container.

While the example of the system shown in FIG. 1 depicts an example of a container including an entry port and an exit port, the invention contemplates a system including a container with a single port (not shown) which can be used to introduce photopolymerizable liquid into the container before printing and which can also be used after printing for discharging the unpolymerized photopolymerizable liquid and any printed objects from the container.

A system can further include one or more optical systems positioned or positionable to selectively direct at least two excitation light projections into a printing zone, preferably though an optically transparent region of the printing zone. The example of the system depicted in FIG. 1 includes two optical systems 111 positioned to direct at least two excitation light projections through one or more optically transparent regions of the container 114 into a printing zone 119.

Optionally, a single optical system can be used to selectively direct at least two excitation light projections into a printing zone (not shown).

The container can be an open container. For example, an open container is not airtight. An open container can optionally include one or more openings while retaining its ability to contain a volume of photopolymerizable liquid. For example, the container can have one or more openings above the volume-containing portion of the container, e.g., a complete or partially open top side of the container and/or one or more openings in a side wall or end of the container. Other configurations may also be determined to be useful.

While an opening in a container can facilitate introduction of photopolymerizable liquid through an open portion thereof, inclusion of an entry port in an open container may be desirable for use in introducing photopolymerizable liquid to the container. For example, dispensing the photopolymerizable liquid through an entry port may permit better control of the amount and/or rate of addition to the container.

The container can be a closable container. Examples of closable containers include, for example, but are not limited to, a container with a removable cover or a hinged cover. A removable or hinged cover can be a full or partial removable cover or a full or partial hinged cover.

Alternatively, the container can be a closed container.

Optionally the container is removable or replaceable.

Optionally the system can further include a gravity discharge mechanism or gravity drainage system for discharging or transporting photopolymerizable liquid and any printed objects contained therein out of the container. Alternatively, a suction mechanism can be used to assist in removal of the contents from the container. Alternatively, a robotic arm or gantry with a grasping mechanism can be used to assist removal of the contents from the container. Alternatively, a piston mechanism can be used to assist removal of the contents from the container. Alternatively, a conveyor mechanism can be used to assist removal of the contents from the container. Other suitable means can be used in the alternative.

Preferably an entry port, if included, and/or the exit port are controllably openable and closable.

The system can further comprise a pressure-exerting device (e.g., a pump, a piston, or the like) in connection with the entry port of the container and adapted for connection to a source of the photopolymerizable liquid, the pump being capable of pumping an amount of the photopolymerizable liquid into the container through the entry port.

Optionally, the system can further include a conveyor situated in the container for transporting the printed object to the exit port for discharge from the container. A conveyor can be situated at the bottom of a container or at such other location in the system that is determined to be useful. It can be beneficial for the conveyor to include an antireflective coating on a side of the conveyor that may be impinged upon by the excitation light in the printing zone. Other coatings that could be included one surface of the conveyor (e.g., the surface transporting printed objects) or, optionally both the surface transporting printed objects and the opposite surface of the conveyor, include anti-corrosion or anti-marring coatings. Other coating materials include polymers such as polyolefins and fluoropolymers

The conveyor can comprise a belt conveyor, including by way of example, but not limited to, a solid belt, a mesh belt, a chain belt, and the like. The belt conveyor can likewise benefit from including an antireflective coating on a side of the belt that may be impinged upon by the excitation light in the printing zone. The conveyor can comprise a trolley or platform made of a magnetizable metal that can be actuated from outside the container using a magnetic field.

The system can further include a separator unit in connection with the exit port of the container for receiving the unpolymerized photopolymerizable liquid and one or more printed three-dimensional objects discharged from the container. The separator unit is configured for separating any printed three-dimensional objects from unpolymerized photopolymerizable liquid included in the discharged contents. A separator unit can include a first discharge port for discharging any separated printed objects from the separator. A separator unit can also include a second discharge port for discharging the separated unpolymerized photopolymerizable liquid from the separator unit for recycling.

The system can further include a recycling unit in connection with the separator unit for receiving the separated unpolymerized photopolymerizable liquid. The recycling unit can recondition the separated unpolymerized photopolymerizable liquid before recirculating it for dispensing it to the container.

The system can further include a recirculation loop in connection with the second discharge port of the separator or in connection with the recycling unit for recirculating the separated unpolymerized photopolymerizable liquid to the source.

The system can further include a control system for controlling at least one of projection of the at least two excitation light projections into one or more of the printing zones, dispensing the photopolymerizable liquid into the container, discharging unpolymerized photopolymerizable liquid and one or more printed three-dimensional objects from the container, and opening and closing the entry port and/or exit port.

The container can have a uniform cross-section over its length dimension

The container channel can alternatively have a non-uniform cross section. A non-uniform cross-section could be used to manipulate the spacing between successive printed objects, e.g., if the cross section gets larger the parts will move closer together; if the cross section gets smaller the parts will move farther apart. Either scenario could be potentially advantageous for object separation.

The channel can have a circular or oval cross-section. The channel can have a polygonal cross-section. The channel can have a rectangular or square cross-section.

Optionally the container has an elongated shape. Other shapes can also be useful.

Examples of elongated containers include tubes, cylinders, with any of the above cross-sections having at least an exit port. An entry port can also be included and positioned relative to the exit port to create a flow path.

As described above, a printing zone is configured to facilitate directing at least two excitation light projections into a printing zone.

To facilitate directing at least two excitation projections into a printing zone, a printing zone can preferably include one or two or more optically transparent regions.

Preferably the optically transparent regions of the container are positioned for directing the excitation light projections into a printing zone in the container.

Optionally, the entire container can be optically transparent, all sides of the printing zone can be optically transparent, one or more sides or the top or bottom of the printing zone can be optically transparent, or the container can include optically transparent windows or regions positioned in the printing zone for passage of the excitation light projections into the printing zone.

A system can further include one or more optical systems positioned or positionable to selectively direct at least two excitation light projections into a printing zone, preferably though an optically transparent region of the printing zone.

Two or more separate optical systems positioned or positionable to selectively direct at least two excitation light projections through the one or more optically transparent regions of the printing zone can be used.

Optionally, a single optical system including two lights sources configured to project two excitation light projections into the printing zone can be used.

Depending upon the photopolymerizable mechanism selected to print a part, the at least two excitation light projections can include the same wavelength or different wavelengths.

Multiple optical systems may be provided to address the same printing zone simultaneously or sequentially, using the same or different excitation lights. For example, two or more optical systems may be positioned on opposite or adjacent sides of the printing zone, or at any other location relative to each other. When multiple optical systems are used to address a single printing zone, excitation light from each optical system may be fully intersecting, partially intersecting, or nonintersecting. It may be desirable for two or more of the optical excitation projections from multiple optical systems to be projected in orthogonal directions. Optionally one or more of the orthogonal excitation light projections can comprise a light sheet.

In accordance with another aspect of the present invention, there is provided a system for printing one or more three-dimensional objects, the system comprising: a closed container including an entry port and an exit port, the entry port and the exit port being connected by a channel therebetween, the closed container including at least one printing zone, wherein a printing zone comprises one or more optically transparent regions to facilitate directing at least at least two excitation light projections into a printing zone through the one or more optically transparent regions to form a three-dimensional printed object within a volume of photopolymerizable liquid in the printing zone, and a pressure-exerting device (e.g., a pump, a piston, or the like) in connection with the entry port of the closed container and adapted for connection to a source of the photopolymerizable liquid, the pressure-exerting device being capable of pumping an amount of the photopolymerizable liquid into the closed container through the entry port.

Preferably the system is capable of being leak tight to prevent undesired leakage of the photopolymerizable liquid. For example, under leak tight conditions, photopolymerizable liquid is retained without loss from leakage in the closed container and without leakage of photopolymerizable liquid at each connection and port when pressurized due to pumping of the photopolymerizable liquid or otherwise.

Optionally the system is capable of being maintained in an inert atmosphere and wherein each connection and port is airtight.

Preferably the system is capable of being light tight except for the printing zone to reduce unwanted photopolymerization and any inspection unit or zone that may utilize light as part of an inspection/characterization technique.

In use, a container included in a system described herein contains with a photopolymerizable liquid to be selectively photopolymerized in the printing zone to form a three-dimensional object.

Optionally the container is removable or replaceable.

The system can further include a separator unit in connection with the exit port of the container for receiving the unpolymerized photopolymerizable liquid and one or more printed three-dimensional objects discharged from the container. The separator unit is configured for separating any printed three-dimensional objects from unpolymerized photopolymerizable liquid included in the discharged contents. A separator unit can include a first discharge port for discharging any separated printed objects from the separator. A separator unit can also include a second discharge port for discharging the separated unpolymerized photopolymerizable liquid from the separator unit for recycling.

The system can further include a recycling unit in connection with the separator unit for receiving the separated unpolymerized photopolymerizable liquid. The recycling unit can recondition the separated unpolymerized photopolymerizable liquid before recirculating it for dispensing it to the container.

The system can further include a recirculation loop in connection with the second discharge port of the separator or in connection with the recycling unit for recirculating the separated unpolymerized photopolymerizable liquid to the source.

The system can further include a control system for controlling at least one of projection of the at least two excitation light projections into one or more of the printing zones, dispensing the photopolymerizable liquid into the container, discharging unpolymerized photopolymerizable liquid and one or more printed three-dimensional objects from the container, and opening and closing the entry port and/or exit port.

The container can have a uniform cross-section over its length dimension

The closed container channel can alternatively have a non-uniform cross section. A non-uniform cross-section could be used to manipulate the spacing between successive printed objects, e.g., if the cross section gets larger the parts will move closer together; if the cross section gets smaller the parts will move farther apart. Either scenario could be potentially advantageous for object separation.

The channel can have a circular or oval cross-section. The channel can have a polygonal cross-section. The channel can have a rectangular or square cross-section.

Optionally the container has an elongated shape. Other shapes can also be useful.

Examples of elongated containers include tubes, cylinders, with any of the above cross-sections having at least an exit port. An entry port can also be included and positioned relative to the exit port to create a flow path.

As described above, a printing zone is configured to facilitate directing at least two excitation light projections into a printing zone.

To facilitate directing at least two excitation projections into a printing zone, a printing zone can preferably include one or two optically transparent regions.

Preferably the optically transparent regions of the container are positioned for directing the excitation light projections into a printing zone in the container. Optionally, the entire container can be optically transparent, all sides of the printing zone can be optically transparent, one or more sides or the top or bottom of the printing zone can be optically transparent, or the container can include optically transparent windows positioned in the printing zone for passage of the excitation light projections into the printing zone.

A system can further include one or more optical systems positioned or positionable to selectively direct at least two excitation light projections into a printing zone, preferably though an optically transparent region of the printing zone.

Two or more separate optical systems positioned or positionable to selectively direct at least two excitation light projections through the one or more optically transparent regions of the printing zone can be used.

Optionally, a single optical system including two lights sources configured to project two excitation light projections into the printing zone can be used.

Depending upon the photopolymerizable mechanism selected to print a part, the at least two excitation light projections can include the same wavelength or different wavelengths.

Multiple optical systems may be provided to address the same printing zone simultaneously or sequentially, using the same or different excitation lights. For example, two or more optical systems may be positioned on opposite or adjacent sides of the printing zone, or at any other location relative to each other. When multiple optical systems are used to address a single printing zone, excitation light from each optical system may be fully intersecting, partially intersecting, or nonintersecting. It may be desirable for two or more of the optical excitation projections from multiple optical systems to be projected in orthogonal directions. Optionally one or more of the orthogonal excitation light projections can comprise a light sheet.

In accordance with another aspect of the present invention, there is provided a system for printing one or more three-dimensional objects, the system comprising: a reservoir for containing a supply of a photopolymerizable liquid, the reservoir having a reservoir outlet and a reservoir inlet, a pressure-exerting device (e.g., a pump, a piston, or the like) in connection with the reservoir outlet for pumping an amount of the photopolymerizable liquid from the reservoir into a closed container through an entry port in the closed container, the closed container including an entry port and an exit port, the entry port and the exit port being connected by a channel therebetween, the closed container including one or more printing zones, wherein a printing zone comprises one or more optically transparent regions to facilitate directing at least two excitation light projections into the printing zone through the one or more optically transparent regions to form a three-dimensional printed object within a volume of photopolymerizable liquid in the printing zone, and a separator unit in connection with the exit port of the closed container for receiving output discharged from the closed container, the separator unit for separating any printed objects from unpolymerized photopolymerizable liquid included in the discharged contents.

Optionally the system is capable of being maintained in an inert atmosphere and wherein each connection and port is airtight.

Preferably the system is capable of being light tight except for the printing zone to reduce unwanted photopolymerization and any inspection unit or zone that may utilize light as part of an inspection/characterization technique.

Preferably the system is capable of being leak tight (also referred to herein as liquid tight) to prevent undesired leakage of the photopolymerizable liquid. For example, under leak tight conditions, photopolymerizable liquid is retained without loss from leakage in the closed container and without leakage of photopolymerizable liquid at each connection and port when pressurized due to pumping of the photopolymerizable liquid or otherwise.

In use, a container included in a system described herein contains a photopolymerizable liquid to be selectively photopolymerized in the printing zone to form a three-dimensional object.

Optionally the container is removable or replaceable.

The separator unit is configured for separating any printed three-dimensional objects from unpolymerized photopolymerizable liquid included in the discharged contents. For example, a separator unit can mechanically separate any printed objects from unpolymerized photopolymerizable liquid.

A separator unit can include a first discharge port for discharging any separated printed objects from the separator. A separator unit can also include a second discharge port for discharging the separated unpolymerized photopolymerizable liquid from the separator unit for recycling.

The system can further include a recycling unit in connection with the separator unit for receiving the separated unpolymerized photopolymerizable liquid. The recycling unit can recondition the separated unpolymerized photopolymerizable liquid before recirculating it for dispensing it to the container.

The system can further include a recirculation loop in connection with the second discharge port of the separator or in connection with the recycling unit for recirculating the separated unpolymerized photopolymerizable liquid to the source.

The system can further include a control system for controlling at least one of projection of the at least two excitation light projections into one or more of the printing zones, dispensing the photopolymerizable liquid into the container, discharging unpolymerized photopolymerizable liquid and one or more printed three-dimensional objects from the container, and opening and closing the entry port and/or exit port.

The container can have a uniform cross-section over its length dimension

The closed container channel can alternatively have a non-uniform cross section. A non-uniform cross-section could be used to manipulate the spacing between successive printed objects, e.g., if the cross section gets larger the parts will move closer together; if the cross section gets smaller the parts will move farther apart. Either scenario could be potentially advantageous for object separation.

The channel can have a circular or oval cross-section. The channel can have a polygonal cross-section. The channel can have a rectangular or square cross-section.

Optionally the container has an elongated shape. Other shapes can also be useful.

Examples of elongated containers include tubes, cylinders, with any of the above cross-sections having at least an exit port. An entry port can also be included and positioned relative to the exit port to create a flow path.

As described above, a printing zone is configured to facilitate directing at least two excitation light projections into a printing zone.

To facilitate directing at least two excitation projections into a printing zone, a printing zone can preferably include one or two optically transparent regions.

Preferably the optically transparent regions of the container are positioned for directing the excitation light projections into a printing zone in the container. Optionally, the entire container can be optically transparent, all sides of the printing zone can be optically transparent, one or more sides or the top or bottom of the printing zone can be optically transparent, or the container can include optically transparent windows positioned in the printing zone for passage of the excitation light projections into the printing zone.

A system can further include one or more optical systems positioned or positionable to selectively direct at least two excitation light projections into a printing zone, preferably though an optically transparent region of the printing zone.

Two or more separate optical systems positioned or positionable to selectively direct at least two excitation light projections through the one or more optically transparent regions of the printing zone can be used.

Optionally, a single optical system including two lights sources configured to project two excitation light projections into the printing zone can be used.

Depending upon the photopolymerizable mechanism selected to print a part, the at least two excitation light projections can include the same wavelength or different wavelengths.

Multiple optical systems may be provided to address the same printing zone simultaneously or sequentially, using the same or different excitation lights. For example, two or more optical systems may be positioned on opposite or adjacent sides of the printing zone, or at any other location relative to each other. When multiple optical systems are used to address a single printing zone, excitation light from each optical system may be fully intersecting, partially intersecting, or nonintersecting. It may be desirable for two or more of the optical excitation projections from multiple optical systems to be projected in orthogonal directions. Optionally one or more of the orthogonal excitation light projections can comprise a light sheet.

The system can further include a conveyor situated in the channel of the closed container to assist in transporting the printed object to the exit port. A conveyor can be situated at the bottom of a container or at such other location in the system that is determined to be useful.

A conveyor useful in a system in accordance with the present invention can comprise a belt conveyor including a solid belt, a mesh belt, a chain conveyor, and the like. It can be desirable for the belt conveyor to include an antireflective coating on a side of the belt that may be impinged upon by the excitation light in the printing zone. Alternatively, or in addition, it can also be desirable for the conveyor to include an antireflective coating on a side of the conveyor that faces the entry point of the excitation light into the printing zone. The conveyor can comprise a trolley or platform made of a magnetizable metal that can be actuated from outside the container using a magnetic field.

In systems described herein that include a pressure-exerting device (e.g., a pump, a piston, or the like), the pressure-exerting device is preferably capable of (i) pumping the photopolymerizable liquid into the container to fill the container with the photopolymerizable liquid and (ii) pumping a metered amount of the photopolymerizable liquid into the filled container to move printed object out of the printing zone in a direction toward the exit port, the exit port being adapted for discharging contents of the container displaced by the metered amount out of the container through the exit port. When a pump or other pressure-exerting device is used, the container is preferably a closed container or a closable container in its closed state.

When a pressure-exerting device (e.g., a pump, a piston, or the like) is included in a system described herein, the pressure-exerting device can comprise a hydrostatic pump. When a pressure-exerting device (e.g., a pump, a piston, or the like) is included in a system described herein, the pressure-exerting device can comprise a peristaltic pump.

A system including a pressure-exerting device may include two pressure-exerting devices wherein a first pressure-exerting device is for moving the photopolymerizable liquid to the printing zone and a pressure-exerting device pump imparts other flow characteristics to the photopolymerizable liquid.

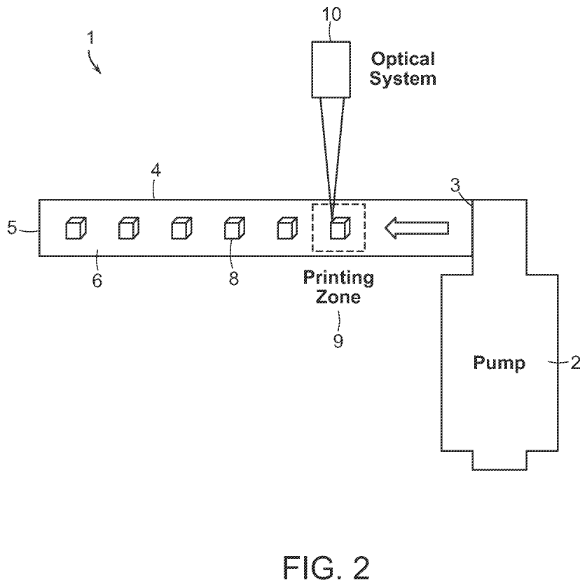

FIG. 2 depicts a diagram of an example of an embodiment of a system in accordance with an aspect of the present invention. The diagram depicts a system 1 including a pump 2 in connection with the entry port 3 of a closed container 4. The pump is adapted for connection to a source of photopolymerizable liquid (not shown). The closed container also includes an exit port 5. The entry port 3 and the exit port 5 are connected by a channel 6 therebetween. As depicted, the channel includes photopolymerizable liquid with a plurality of three-dimensional printed objects 8 therein, one of which is in the printing zone 9, the others spaced apart due to successive displacement from the printing zone toward the exit port by a series of separate additions of new amounts of photopolymerizable liquid pumped into the closed container by the pump. The arrow depicted in FIG. 2 indicates the direction of the flow of the photopolymerizable liquid in the channel from the entry point where the liquid is introduced into the closed container to the exit port through which contents are discharge from the closed container.

Preferably the system is capable of being leak tight to prevent undesired leakage of the photopolymerizable liquid. For example, under leak tight conditions, photopolymerizable liquid is retained without loss from leakage in the closed container and without leakage of photopolymerizable liquid at each connection and port when pressurized due to pumping of the photopolymerizable liquid or otherwise.

The system is optionally capable of being maintained in an inert atmosphere and each of the connections and ports are airtight.

Preferably the system is capable of being light tight except for the printing zone to reduce unwanted photopolymerization and any inspection unit or zone that may utilize light as part of an inspection/characterization technique.

For illustration purposes, the channel portion of the closed container is depicted as optically transparent. While it may be desirable in some instances for the channel portion of the closed container or the entire closed container to be entirely optically transparent, at least a region in the closed container is optically transparent to facilitate passing excitation from an optical system into the photopolymerizable liquid in the printing zone to print an object.

In some instances, it may be desirable for portions of the closed container adjacent a printing zone to not be optically transparent to help prevent excitation light from spreading into areas of the closed container outside the printing zone in which photopolymerization is not desired.

Additional information relating to the closed container and pump is provided below.

The system can further include one or more optical systems external to a printing zone of the closed container. The optical system can optionally be separately provided or can be included as part of the system in combination with the closed container and pump.

For illustration purposes, a single optical system 10 is depicted in FIG. 2. As discussed above, a single optical system that can generate two excitation light projections or multiple optical systems may be provided to address the same printing zone simultaneously or sequentially, using two more excitation light projections that can include the same or different wavelength. For example, two or more optical systems may be positioned on opposite or adjacent sides of the printing zone, or at any other location relative to each other. When multiple optical systems are used to address a single printing zone, excitation light from each optical system may be fully intersecting, partially intersecting, or nonintersecting.

An optical system can be in connection with at least one excitation light source. The optical system is positioned or positionable to irradiate the excitation light through the at least one optically transparent region of the printing zone.

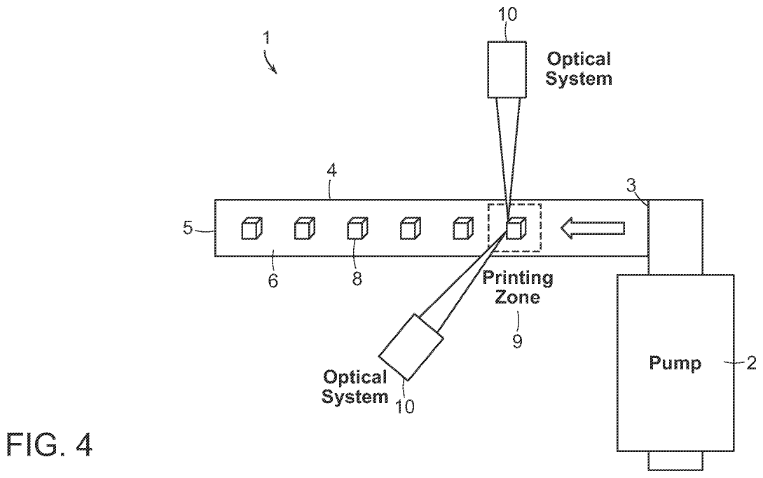

FIG. 2 depicts an example of an optical system 10 positioned over a printing zone in the closed container. FIG. 4 depicts an example of the system shown in FIG. 2 including two optical systems 10 positioned to direct excitation light projections into a printing zone.

Optionally, the at least one optical system used with or included in the system can be movable in relation to the printing zone such that at least two excitation light projections can be irradiated into the printing zone from one or more sides of the printing zone (e.g., from the top, one side, both sides, the bottom, or any combination including two or more sides). If a movable optical system is to be used, the printing zone will include transparent portions or regions to accommodate irradiation of excitation light into the printing zone from one or more sides. For example, each side or surface of the printing zone through which the excitation light is to be irradiated will be optically transparent or at least include an optically transparent region through which the excitation light can pass.

Optionally, the excitation light can be temporally and/or spatially modulated. Optionally, the intensity of the excitation light can be modulated.

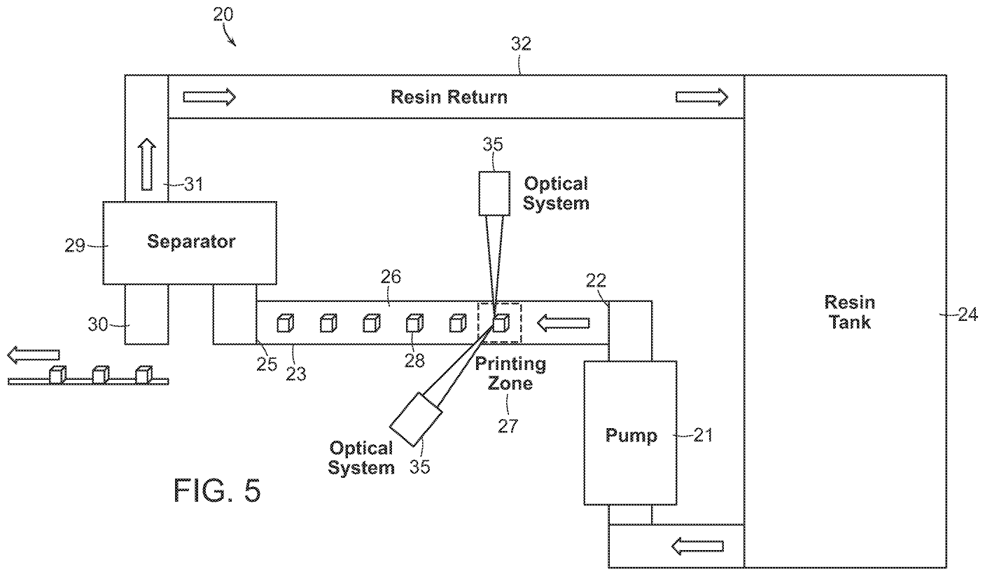

Optionally, two or more optical systems direct excitation light of multiple wavelengths through two or more optically transparent regions into a printing zone. Preferably, at least one optical system directing excitation light of a first wavelength can be modulated. Preferably, at least one optical system directing excitation light of a second wavelength is movable in relation to the printing zone. FIGS. 4 and 5 depict examples of systems of the invention including two optical systems positioned to direct excitation light projections into a printing zone.

Spatially modulated excitation light can be created by known spatial modulation techniques, including, for example, a liquid crystal display (LCD), a digital micromirror display (DMD), a microLED array, a grating light valve, a galvanometer scanner, or a polygon mirror scanner. Other known spatial modulation techniques can be readily identifiable by those skilled in the art.

The optical system can be selected to apply continuous excitation light. The optical system can be selected to apply intermittent excitation light. Intermittent excitation can include random on and off application of light or periodic application of light. Examples of periodic application of light includes pulsing. The optical system can be selected to apply a combination of both continuous excitation light and intermittent light, including, for example, an irradiation step that includes the application of intermittent excitation light that is preceded or followed by irradiation with continuous light.

Preferably, the excitation light has a wavelength in the visible or ultraviolet range.

The optical system can be movable in one or more of the x, y, and z directions in relation to a given printing zone.

Optionally a printing zone can be entirely optically transparent.

The system can optionally include more than one printing zone. Each printing zone will include at least one optically transparent region to facilitate the irradiation of at least two excitation light projections into the photopolymerizable liquid in each printing zone. As discussed above, other portions or all of a printing zone can be optically transparent to accommodate at least one the optical system to be used and its movability.

When the system includes more than one printing zone, the system can include one or more optical systems associated with each printing zone. Alternatively, when the system includes more than one printing zone, the system can include one or more optical systems that are movable in relation to at least the locations of the printing zones in the closed container and repositionable for irradiating excitation light into each of the printing zones, one at a time.

The system can optionally further include a separator unit (not shown in FIG. 2) in connection with the exit port of the closed container for receiving contents discharged from the closed container. The separator unit is for separating any printed objects from unpolymerized photopolymerizable liquid included in the discharged contents, the separator unit including a first discharge port for discharging any separated printed objects from the separator unit and a second discharge port for discharging the separated unpolymerized photopolymerizable liquid from the separator unit. Optionally, the second discharge port of the separator unit is adapted for connection to a return line or recirculation loop for recirculating the separated unpolymerized photopolymerizable liquid to the source of the photopolymerizable liquid to be pumped into the closed container.

The separator unit is optionally sealed to prevent introduction of air or oxygen into the unit during separation.

The separator unit preferably mechanically separates any printed objects from the unpolymerized photopolymerizable liquid in the contents discharged from the closed contained. Examples of techniques for mechanically separating print objects from unpolymerized photopolymerizable liquid in the discharged contents include, but are not limited to, screening techniques, use of a scoop or claw to extract any printed objects from the discharged contents, a cyclonic separator, a spiral separator, a compressed gas curtain (e.g., air knife); and a combination of two or more techniques. Heating of the unpolymerized photopolymerizable liquid in addition to applying stress may further enhance the ability of the liquid to flow off and separate from the part.

The separated unpolymerized photopolymerizable liquid can be treated or reconditioned after separation from any printed objects. Examples of such treatments include, without limitation, cleaning/purification, filtering, degassing, centrifugation, solvent, or monomer addition.

The printed objects collected from the separator unit can optionally be post-treated.

Examples of post-treatments include, but are not limited to, washing, post-curing (e.g., by heat, non-ionizing radiation, ionizing radiation, humidity, pressure, or simultaneous or sequential combinations of techniques), metrology, labelling or tagging with a trackable device (e.g., barcode, QR code, RFID tag), freeze-dry processing, critical point drying, sterilization (e.g., by UV, X-ray, e-beam, ethylene oxide, ozone), and packaging.

Optionally, a system can further include a post-treatment unit or region for carrying out one or more selected post-treatment steps on printed objects after isolation from unpolymerized photopolymerizable liquid. A post-treatment unit or region can be configured for receiving the separated printed objects from the separator unit.

In accordance with a still further another aspect of the present invention, there is provided a system for printing one or more three-dimensional objects, the system comprising: a reservoir for containing a supply of a photopolymerizable liquid, the reservoir having a reservoir outlet and a reservoir inlet, a pressure-exerting device (e.g., a pump, a piston, or the like) in connection with the reservoir outlet for pumping an amount of the photopolymerizable liquid from the reservoir into a closed container through an entry port in the closed container, the closed container including the entry port and an exit port, the entry port and the exit port being connected by a channel therebetween, the closed container including at least one printing zone, a printing zone comprising at least one optically transparent region to facilitate directing at least two excitation light projections at one or more wavelengths into a printing zone through the at least one optically transparent region to form a three-dimensional printed object from the photopolymerizable liquid in the printing zone, and a separator unit in connection with the exit port of the closed container for receiving contents discharged from the closed container. The separator unit is capable of separating any printed objects from unpolymerized photopolymerizable liquid included in the discharged contents. The separator unit also feeds any separated printed objects out of the separator unit through a first discharge port for collection and/or post-treatment. The separator unit also includes a second discharge port for discharging the separated unpolymerized photopolymerizable liquid from the separator unit. Optionally, the separator unit further includes a return line or recirculation loop in connection with the second discharge port for recirculating the separated unpolymerized photopolymerizable liquid to the reservoir.

The system can further include one or more optical systems positioned or positionable to direct at least two excitation light projections into the printing zone.

Preferably the system is capable of being leak tight wherein photopolymerizable liquid is retained without loss in the closed container and at each connection and port including when pressurized due to pumping of the photopolymerizable liquid.

Optionally the system is capable of being maintained in an inert atmosphere and each of the connections and ports are airtight.

Optionally the system is capable of being light tight except for the printing zone to reduce unwanted photopolymerization and any inspection unit or zone that may utilize light as part of an inspection/characterization technique.

In use, a container included in a system described herein contains a photopolymerizable liquid to be selectively photopolymerized in the printing zone to form a three-dimensional object.

The systems and methods described herein preferably include a photopolymerizable liquid that displays non-Newtonian rheological behavior and the at least two excitation light projections are selectively directed into the printing zone to selectively photopolymerize the photopolymerizable liquid at one or more selected locations in the printing zone to form a printed object without support structures, wherein the printed object remains at a fixed position or is minimally displaced in the unpolymerized photopolymerizable liquid during formation.

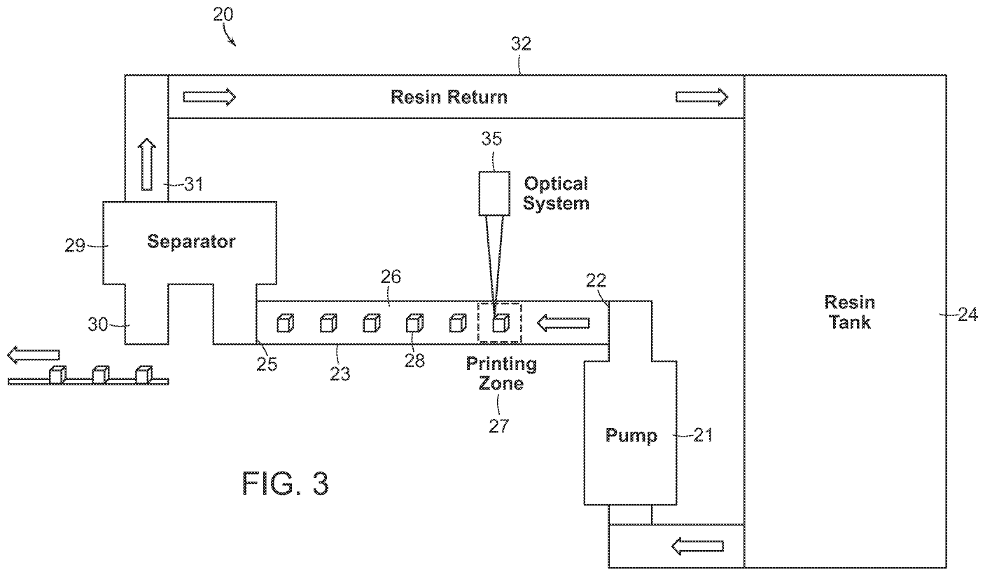

FIG. 3 depicts a diagram of an example of an embodiment of a system in accordance with an aspect of the present invention. The diagram depicts a system 20 including a pump 21 in connection with the entry port 22 of a closed container 23. The pump is adapted for connection to a reservoir (labeled “Resin Tank” in the FIG. 24 for containing a photopolymerizable liquid. The closed container also includes an exit port 25. The entry port 22 and the exit port 25 are connected by a channel 26 therebetween. As depicted, the channel includes photopolymerizable liquid with a plurality of three-dimensional printed objects 28 therein, one of which is in the printing zone 27, the others being spaced apart due to successive displacement from the printing zone toward the exit port by a series of separate additions of new amounts of photopolymerizable liquid pumped into the closed container by the pump. The arrow depicted in FIG. 3 indicates the direction of the flow of the photopolymerizable liquid in the channel from the entry point where the liquid is introduced into the closed container to the exit port where contents are discharge from the closed container. The displaced contents include unpolymerized photopolymerizable liquid and any printed object included therein that has been displaced from the printing zone and transported along the length of the channel to the exit port through a series of additions of new photopolymerizable liquid into the closed container by the pump. The discharged contents exit the closed container through the exit port and pass into a separator unit (labeled “Separator” in the FIG. 29 in connection with the exit port. The separator unit is capable of separating any printed objects from unpolymerized photopolymerizable liquid included in the discharged contents. The separator unit also feeds any separated printed objects out of the separator unit through a first discharge port 30 for collection and/or post-treatment. The separator unit also includes a second discharge port 31 for discharging the separated unpolymerized photopolymerizable liquid from the separator unit.

The separator unit is optionally sealed to prevent introduction of air or oxygen into the unit during separation.

The separator unit preferably mechanically separates any printed objects from the unpolymerized photopolymerizable liquid in the contents discharged from the closed contained. Examples of techniques for mechanically separating printed objects from unpolymerized photopolymerizable liquid in the discharged contents include, but are not limited to, screening techniques, use of a scoop or claw to extract any printed objects from the discharged contents, a cyclonic separator, a spiral separator, a compressed gas curtain (e.g., air knife); and a combination of two or more techniques.

The separated unpolymerized photopolymerizable liquid can be treated after separation from any printed objects. Examples of such treatments include, without limitation, cleaning/purification, filtering, degassing, or addition of solvent or monomer.

Optionally, the system further includes a return line or recirculation loop (labeled “Resin Return” in the FIG. 32 in connection with the second discharge port 31 of the separator unit for recirculating the separated unpolymerized photopolymerizable liquid to the reservoir 24.

The printed objects collected from the separator unit can optionally be post-treated.

Examples of post-treatments include, but are not limited to, washing, post-curing (e.g., by heat, non-ionizing radiation, ionizing radiation, humidity, pressure, or simultaneous or sequential combinations of techniques), metrology, labelling or tagging with a trackable device (e.g., barcode, QR code, RFID tag), freeze-dry processing, critical point drying, sterilization (e.g., by UV, X-ray, e-beam, ethylene oxide, ozone), and packaging.

Optionally, a system can further include a post-treatment unit or region for carrying out one or more selected post-treatment steps on printed objects after isolation from unpolymerized photopolymerizable liquid. A post-treatment unit or region can be configured for receiving the separated printed objects from the separator unit.

For illustration purposes, the channel portion of the closed container is depicted as optically transparent.

While it may be desirable in some instances for the channel portion of the closed container or the entire closed container to be entirely optically transparent, at least a region in the closed container is optically transparent to facilitate passing excitation from an optical system into the photopolymerizable liquid in the printing zone to print an object.

In some instances, it may be desirable for portions of the closed container adjacent a printing zone to not be optically transparent to help prevent excitation light from spreading into areas of the closed container outside the printing zone in which polymerization is not desired.

Additional information relating to the closed container and pump is provided below.

The system can further include one or more optical systems external to a printing zone of the closed container. For illustration purposes, a single optical system 35 is depicted in FIG. 3. As discussed above, a single optical system that can generate two excitation light projections or multiple optical systems may be provided to address the same printing zone simultaneously or sequentially, using two more excitation light projections that can include the same or different wavelength. Multiple optical systems may be provided to address the same printing zone simultaneously or sequentially, using two or more optical projections that can include the same or different excitation light wavelengths. For example, two or more optical systems may be positioned on opposite or adjacent sides of the printing zone, or at any other location relative to each other. When multiple optical systems are used to address a single printing zone, excitation light from each optical system may be fully intersecting, partially intersecting, or nonintersecting.

The at least one optical system can optionally be separately provided or can be included as part of the system in combination with the closed container and pump.

An optical system can be in connection with one or more excitation light sources. The optical system is positioned or positionable to irradiate the excitation light through the at least optically transparent region of the printing zone.

FIG. 3 depicts an optical system 35 positioned over a printing zone in the closed container. FIG. 5 depicts an example of the system shown in FIG. 3 including two optical systems 35 positioned to direct excitation light projections into a printing zone.

Optionally, the one or more optical systems used with or included in the system can be movable in relation to the printing zone such that excitation light can be irradiated into the printing zone from one or more sides of the printing zone (e.g., from the top, one side, both sides, the bottom, or any combination including two or more sides). If a movable optical system is to be used, the printing zone will include transparent portions to accommodate irradiation of excitation light into the printing zone from one or more sides. For example, each side or surface of the printing zone through which the excitation light is to be irradiated will be optically transparent or at least include an optically transparent region through which the excitation light can pass.

Optionally, the excitation light can be temporally and/or spatially modulated. Optionally, the intensity of the excitation light can be modulated.

Optionally, two or more optical systems direct excitation light of multiple wavelengths through two or more optically transparent regions into a printing zone. Preferably, at least one optical system directing excitation light of a first wavelength can be modulated. Preferably, at least one optical system directing excitation light of a second wavelength is movable in relation to the printing zone.

Spatially modulated excitation light can be created by known spatial modulation techniques, including, for example, a liquid crystal display (LCD), a digital micromirror display (DMD), a microLED array, a grating light valve, a galvanometer scanner, or a polygon mirror scanner. Other known spatial modulation techniques can be readily identifiable by those skilled in the art.

The optical system can be selected to apply continuous excitation light. The optical system can be selected to apply intermittent excitation light. Intermittent excitation can include random on and off application of light or periodic application of light. Examples of periodic application of light includes pulsing. The optical system can be selected to apply a combination of both continuous excitation light and intermittent light, including, for example, an irradiation step that includes the application of intermittent excitation light that is preceded or followed by irradiation with continuous light.

Preferably, the excitation light has a wavelength in the visible or ultraviolet range.

The optical system can be movable in one or more of the x, y, and z directions in relation to a given printing zone.

Optionally a printing zone can be entirely optically transparent.

The system can optionally include more than one printing zone. Each printing zone will include at least one optically transparent region to facilitate directing at least two excitation light projections into the photopolymerizable liquid in each printing zone. As discussed above, other portions or all of a printing zone can be optically transparent to accommodate the one or more optical systems to be used and their movability.

When the system includes more than one printing zone, the system can include one or more optical systems associated with each printing zone. Alternatively, when the system includes more than one printing zone, the system can include one or more optical systems that are movable in relation to at least the locations of the printing zones in the closed container and repositionable for irradiating excitation light into each of the printing zones, one at a time.

A system described herein is preferably configured to facilitate carrying out the functions to be performed by the components of the system in a continuous manner.

To permit customization of the 3D printing process to be carried by a system described herein, it may be desirable for a system to be fully or partially modular to accommodate one or more components of a system to be exchanged with one or more replacement components for performing similar respective functions but including features and/or capabilities for achieving the particular customization that is desired. For example, a container could be replaced by a larger or smaller container to accommodate different size or capacity, a container could be replaced by multiple containers, a container could be replace by one including one or more optically transparent regions configured to accommodate the one or more optical systems selected for use; an optical system could be replaced by one or more systems with different excitation wavelength and/or power capabilities; a pump could be replaced by one or more pumps with different performance features; an optional reservoir could be replaced by a different size reservoir and/or a multi-chamber reservoir for permitting selection and introduction of a photopolymerizable liquid from one or more of the chambers into the container; a separator, if included in the system, could be replaced by a separator that achieves separation of printed parts from unpolymerized photopolymerizable liquid by a particular technique; a post-treatment component, if included, could be selected based on the desired post-treatment steps selected.

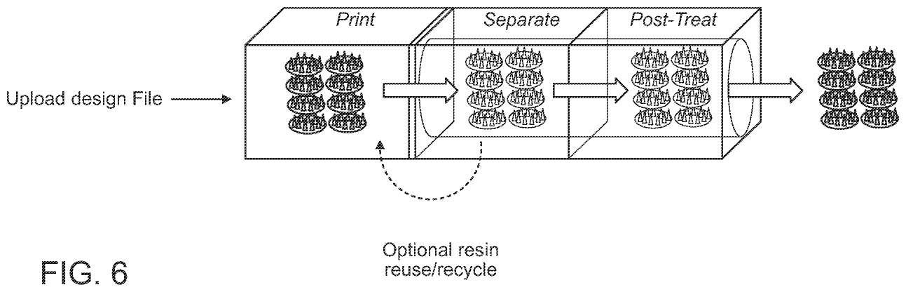

FIG. 6 depicts an example of a system in accordance with the present invention including a printing unit (including a container), a separator, and a post-treatment module or region. Optionally, one or more optical systems can be including in the printing unit or the printing unit can be adapted for use with one or more external optical systems. The printing unit and/or optical systems (whether internal to the printing unit or external thereto) can further be adapted to movable, for example, in one or more of x, y, and z directions for selectively directing excitation light projections, preferably at least two excitation light projections, to one or more selected locations in the container during printing or forming 3D objects. Such movement can be achieved with including of an x, y, z-translation stage (not shown). Optionally, as discussed herein, the unpolymerized photopolymerizable liquid from which the printed objects are separated can be reused or recycled. (The example depicted in FIG. 6 does not show a pump or pressure-exerting device or a dispensing system. A pump or pressure-exerting device or a dispensing system can optionally be included in the printing unit, or alternatively external to the printing unit and adapted for connection thereto.)

The depicted example can comprise a system including, separate modules in operable connection for 3D-printing objects having a selected design in a volume of photopolymerizable liquid included in the printing zone of a container, discharging the content of at least the printing zone into a separator to separate the printed objects from the unpolymerized photopolymerizable liquid, and transporting the separated printing objects into a post-treatment unit or region of the system for carrying out one or more desired post-treatment steps.

Alternatively, in the depicted example, the system can comprise a system in which one or more of the units or components are included in a unitary housing. In the depicted example, it can be desirable for the printing unit (including a container), separator, and post-treatment unit or region to be included in a unitary housing.

In accordance with yet a further aspect of the present invention, there is provided a method of printing one or more three-dimensional objects, the method comprising: providing a volume of a photopolymerizable liquid in a container configured to contain a volume of a photopolymerizable liquid, the container including an exit port, the exit port facilitating discharge of photopolymerizable liquid and one or more of any printed three-dimensional objects contained therein from the container, the container including one or more printing zones, wherein a printing zone is configured to facilitate directing at least two excitation light projections into the printing zone to form a three-dimensional printed object within the volume of photopolymerizable liquid in the printing zone, directing the at least two excitation light projections into the printing zone to selectively photopolymerize the photopolymerizable liquid at one or more selected locations in the printing zone, and discharging the photopolymerizable liquid and any printed objects contained therein out of the container.

The method can further include separating any printed objects from unpolymerized photopolymerizable liquid included in the discharged contents.

Optionally, the method further comprises recycling the separated unpolymerized photopolymerizable liquid from the discharged contents.

Optionally the method is carried out in an inert atmosphere.

In accordance with yet another aspect of the present invention, there is provided a method of printing one or more three-dimensional objects, the method comprising: providing a volume of a photopolymerizable liquid in a container including an entry port and an exit port, the entry port facilitating introduction of photopolymerizable liquid into the container and the exit port facilitating passage of unpolymerized photopolymerizable liquid and one or more printed three-dimensional object from the container, the container including one or more printing zones, wherein a printing zone is configured to facilitate directing at least two excitation light projections into the printing zone to form a three-dimensional printed object within a volume of photopolymerizable liquid in the printing zone, wherein the photopolymerizable liquid preferably displays non-Newtonian rheological behavior such that the object formed in the photopolymerizable liquid within the printing zone remains at a fixed position or is minimally displaced in the unpolymerized photopolymerizable liquid during formation, directing the at least two excitation light projections into the printing zone to selectively photopolymerize the photopolymerizable liquid in the printing zone without support structures to form a printed object, wherein the printed object remains at a fixed position or is minimally displaced in the unpolymerized photopolymerizable liquid during formation, and applying pressure to the contents of the container and/or pumping additional photopolymerizable liquid into the container through the entry port to at least transport the printed object out of the printing zone toward the exit port thereby discharging at least a portion of contents of the container out of the container through the exit port.

The method can further include separating any printed objects from unpolymerized photopolymerizable liquid included in the discharged contents.

Optionally, the method further comprises recycling the separated unpolymerized photopolymerizable liquid from the discharged contents.

Optionally the method is carried out in an inert atmosphere.

In accordance with yet another aspect of the present invention, there is provided a method of printing one or more three-dimensional objects. The method includes providing a volume of a photopolymerizable liquid in a closed container. The photopolymerizable liquid preferably displays non-Newtonian rheological behavior such that the object formed in the photopolymerizable liquid within the printing zone remains at a fixed position or is minimally displaced in the unpolymerized photopolymerizable liquid during formation. The closed container includes an entry port and an exit port, the entry port and the exit port being connected by a channel therebetween. The closed container also includes at least one printing zone in which the object is formed. Each printing zone includes at least one optically transparent region through which at least two excitation light projections at one or more wavelengths can be irradiated into a printing zone. The method also includes directing the at least two excitation light projections through the at least one optically transparent region into the printing zone to selectively photopolymerize the photopolymerizable liquid in the printing zone without the addition of support structures to form a printed object. The printed object remains at a fixed position or is minimally displaced in the unpolymerized photopolymerizable liquid during formation. The method further includes applying pressure to the contents of the closed container and/or pumping additional photopolymerizable liquid into the closed container through the entry port to at least transport the printed object out of the printing zone toward the exit port, thereby discharging at least a portion of contents of the closed container out of the closed container through the exit port.

The method can further include separating any printed objects from unpolymerized photopolymerizable liquid included in the discharged contents.

Optionally, the method further comprises recycling the separated unpolymerized photopolymerizable liquid from the discharged contents.

Optionally the method is carried out in an inert atmosphere.

The various systems described herein may be useful in carrying out the various methods described herein.

In one example of the method, 1) a resin is photocured without support structures so that the part is suspended in resin; 2) the resin is thixotropic (shear-thinning) or has a yield stress, such that during the curing operation the part remains fixed in space or undergoes a minimal amount of displacement; 3) upon application of pressure the cured part or parts are moved out of the printing zone and the printing zone is refilled with new resin; 4) the parts are separated from the resin; and 5) the resin is optionally recycled.

The method of the present invention can produce one or more printed objects utilizing light-induced solidification of a photopolymerizable liquid that includes a photopolymerizable component which preferably displays non-Newtonian rheological behavior. Examples of such non-Newtonian rheological behavior include pseudoplastic fluid, yield pseudoplastic, Bingham pseudoplastic, or Bingham plastic. This behavior may be due to the combination of reactive components in the resin (monomers and oligomers) or imparted by a nonreactive additive (thixotrope, rheology modifier).

Non-Newtonian rheological behavior can be imparted to the photohardenable composition by further including one or more reactive components (e.g. urethane acrylate oligomers, urethane methacrylate oligomers, acrylated or methacrylated polyurethanes, acrylated or methacrylated polyurethane-ureas, acrylated or methacrylated polyesters, acrylated or methacrylated polyamides, acrylate- or methacrylate-functional block copolymers, alkenyl- or alkynyl-functional urethane oligomers, alkenyl- or alkynyl-functional polyurethanes, alkenyl- or alkynyl-functional polyurethane-ureas, alkenyl- or alkynyl-functional polyesters, alkenyl- or alkynyl-functional polyamides, alkenyl- or alkynyl-functional block copolymers, thiol-functional urethane oligomers, thiol-functional polyurethanes, thiol-functional polyurethane-ureas, thiol-functional polyesters, thiol-functional polyamides, thiol-functional block copolymers) in the photohardenable component and/or by further adding one or more nonreactive additives (e.g., but not limited to, one or more thixotropes and/or rheology modifiers) to the photohardenable composition. Selection of the one or more of reactive components and the amounts thereof for addition to the photohardenable component to impart non-Newtonian rheological behavior thereto is within the skill of the skilled artisan in the relevant art without undue experimentation. Similarly, selection of nonreactive additives and the amount(s) thereof for addition to the photohardenable composition to impart non-Newtonian rheological behavior thereto is within the skill of the skilled artisan of the relevant art without undue experimentation.

Formulation of photopolymerizable liquids that display non-Newtonian behavior is within the skill of skilled artisan in the relevant art. By way of example, and without limitation, a formulation of a photopolymerizable liquid for use in the methods and systems described herein includes a formulation comprising 86 parts GENOMER 4259 (an aliphatic urethane acrylate), 14 parts N,N-dimethylacrylamide, 13.3 parts 60 wt % upconverting nanoparticle dispersion in N,N-dimethylacrylamide, 2 parts Rheobyk 410 thixotrope, 0.5 parts Bis(2,6-difluoro-3-(1-hydropyrrol-1-yl)phenyl)titanocene photoinitiator, 0.001 parts 2,2,6,6-Tetramethyl-1-piperidinyloxy free radical inhibitor. An additional non-limiting example of a formulation of a photopolymerizable liquid for use in the methods and systems described herein includes a formulation comprising 90 parts GENOMER 4247 (an aliphatic urethane methacrylate), 10 parts N,N-dimethylacrylamide, 1.2 parts Crystasense HP-5 thixotrope (a polyalkyleneoxy terminated polyamide), 0.20 parts butyryl choline butyltriphenylborate, and 0.005 parts 1′-benzyl-3′,3′-dimethyl-8-iodo-7-methoxy-6-nitrobenzospiropyran.

The printed object is formed in a volume of photopolymerizable liquid by application of light. preferably at least two excitation projection, in a printing zone, without the production of support structures, and due to the rheological behavior (high zero-shear viscosity or yield stress), the part displaces by a minimal amount that is acceptable for precisely reproducing the intended part geometry during the time interval required to form the part. Once the part is formed, the part is displaced from the printing zone by applying pressure and/or pumping additional photopolymerizable liquid into the closed container or other means, which causes the photopolymerizable liquid to flow. While the object experiences little or no displacement during formation in the printing zone, when the object is displaced from the printing zone by pumping pressure and/or the addition of additional photopolymerizable liquid to the closed container, it may experience positional displacement in the contents as it is moved toward the exit port.

In accordance with yet another aspect of the present invention, there is provided a system for printing one or more three-dimensional objects, the system comprising: a container including an entry port and an exit port, the entry port and the exit port being connected by a flow path therebetween, the container including a printing zone, wherein the printing zone comprises at least one optically transparent region to facilitate directing an excitation light into the printing zone through the optically transparent region to form a three-dimensional printed object within a volume of photopolymerizable liquid in the printing zone, and a pressure-exerting device (e.g., a pump, a piston, or the like) in connection with the entry port of the container and adapted for connection to a source of the photopolymerizable liquid, the pressure-exerting device being capable of pumping an amount of the photopolymerizable liquid into the container through the entry port.

Preferably the excitation light comprises at least two excitation light projections.

The system can further include a separator unit in connection with the exit port of the container for receiving the discharged contents from the container, the separator unit for separating any printed objects from unpolymerized photopolymerizable liquid included in the discharged contents, the separator unit including a first discharge port for discharging any separated printed objects from the separator unit and a second discharge port for discharging the separated unpolymerized photopolymerizable liquid from the separator unit.

The system can further include a recirculation loop in connection with the second discharge port for recirculating the separated unpolymerized photopolymerizable liquid to the source.

The system can further include a reservoir for containing a supply of a photopolymerizable liquid, the reservoir having a reservoir outlet and a reservoir inlet.

The system can further include one or more optical systems positioned or positionable to irradiate excitation light, preferably comprising least two excitation light projections, through the optically transparent region of a printing zone.

The system can further include a reservoir for containing a supply of a photopolymerizable liquid, the reservoir having a reservoir outlet and a reservoir inlet.

Additional information that may be helpful concerning the components of this system can be found elsewhere herein in discussion of other aspects of the present invention.

In accordance with still another aspect of the present invention, there is provided a method of printing one or more three-dimensional objects, the method comprising: providing a volume of a photopolymerizable liquid in a container including an entry port and an exit port, the entry port and the exit port being connected by a flow path therebetween, the container including at least one printing zone comprising at least one optically transparent region to facilitate directing excitation light into a printing zone through the at least one optically transparent region, directing the excitation light through the at least an optically transparent window into the printing zone to selectively photopolymerize the photopolymerizable liquid in the printing zone without support structures to form a printed object. wherein the printed object remains at a fixed position or is minimally displaced in the unpolymerized photopolymerizable liquid during formation, and applying pressure to the contents of the container and/or pumping additional photopolymerizable liquid into the container through the entry port to at least transport the printed object out of the printing zone toward the exit port, thereby discharging at least a portion of contents of the container out of the container through the exit port.

Preferably the excitation light comprises at least two excitation light projections.

The method can further comprise separating any printed objects from unpolymerized photopolymerizable liquid included in the discharged contents.

The method can further comprise recirculating the discharged unpolymerized photopolymerizable liquid after separation of any printed objects to a reservoir

Preferably the photopolymerizable liquid displays non-Newtonian rheological behavior such that the object formed in the photopolymerizable liquid within the printing zone remains at a fixed position or is minimally displaced in the unpolymerized photopolymerizable liquid during formation, directing the excitation light through the at least an optically transparent window into the printing zone to selectively photopolymerize the photopolymerizable liquid in the printing zone without support structures to form a printed object, wherein the printed object remains at a fixed position or is minimally displaced in the unpolymerized photopolymerizable liquid during formation.

More preferably the photopolymerizable liquid comprises a photohardenable component (also referred to herein as a photopolymerizable component), a photoswitchable photoinitiator and a coinitiator, wherein the photoswitchable photoinitiator is activatable by exposure to light having a first wavelength and light having a second wavelength to induce a crosslinking or polymerization reaction in the photohardenable component, wherein the first and second wavelengths are different, wherein the photopolymerizable composition displays non-Newtonian rheological behavior.

Additional information that may be helpful concerning the components/steps included of this method can be found elsewhere herein in discussion of other aspects of the present invention.

Methods and systems in accordance with the present invention are additionally particularly useful for printing 3D objects from photopolymerizable liquids that demonstrate non-Newtonian behavior and which can be solidified at volumetric positions impinged upon by excitation light at a first wavelength by upconversion-induced photopolymerization.

An example of a preferred photopolymerizable liquid includes (i) a photopolymerizable component; (ii) upconverting nanoparticles including a sensitizer (a sensitizer used with an annihilator for upconversion being hereinafter referred to as “UC sensitizer”) and a annihilator, the UC sensitizer comprising molecules selected to absorb light at the first wavelength and generate triplet excitons and the annihilator being selected to emit light at a second wavelength after transfer of energy from the UC sensitizer to the annihilator, the second wavelength being shorter than the first wavelength; and (iii) a photoinitiator that initiates polymerization of the photopolymerizable component upon excitation by light at the second wavelength, wherein the photopolymerizable liquid demonstrates non-Newtonian behavior.

The first and second wavelengths can be in the visible or ultraviolet range.

As discussed herein, a photopolymerizable liquid can preferably include: a photopolymerizable component; upconverting nanoparticles including a core portion that includes a UC sensitizer and an annihilator in a liquid (e.g., oleic acid) and an encapsulating coating or a shell (e.g., silica) over at least a portion, and preferably substantially all, the outer surface of the core portion, wherein the UC sensitizer comprises a molecule selected to absorb light at the first wavelength and generate triplet excitons and the annihilator being selected to emit light at a second wavelength after transfer of energy from the UC sensitizer to the annihilator, the second wavelength being shorter than the first wavelength; and a photoinitiator that initiates polymerization of the photopolymerizable component upon excitation by light at the second wavelength. The upconverting nanoparticles can further include ligands at the surface thereof for facilitating distribution of the nanoparticles in the photopolymerization component. Surfactants and other materials useful as ligands are commercially available. Examples of ligands include, but are not limited to, poly(ethylene glycol).

An annihilator may also be referred to as a triplet annihilator.

Upconverting nanoparticles preferably have an average particle size less than the wavelength of the exciting light. Examples of preferred average particle sizes are less than 100 nm, less than 80 nm, less than 50 nm, less than 30 nm, less than 20 nm, although still larger, or smaller, nanoparticles can also be used. Most preferably, the upconverting nanoparticles have an average particle size that creates no appreciable light scattering.

Examples of materials for use as UC sensitizers and annihilators are described in International Application No. PCT/US2019/063629, of Congreve, et al., filed Nov. 27, 2019, S. Sanders, et al., “Photon Upconversion in Aqueous Nanodroplets”, J. Amer. Chem. Soc. 2019, 141, 9180-9184, and Beauti, Sumar, Abstract entitled “Search for New Chromophore Pairs for Triplet-Triplet Annihilation Upconversion” ISEF Projects Database, Finalist Abstract (2017), available at https://abstracts.societyforscience.org. each of the foregoing being hereby incorporated herein by reference in its entirety. WO2019/025717 of Baldeck et al., published Feb. 7, 2019, and International Application No. PCT/US2019/063629, of Congreve, et al., filed Nov. 27, 2019 also provide information that may be useful concerning the concentration of the upconverting nanoparticles and the concentrations of the UC sensitizer and annihilator in the photopolymerizable liquid.

An annihilator can comprise molecules capable of receiving a triplet exciton from a molecule of the UC sensitizer through triplet-triplet energy transfer, undergo triplet fusion with another annihilator molecule triplet to generate a higher energy singlet that emits light at a second wavelength to excite the photosensitizer to initiate polymerization of the photopolymerizable component. Examples of annihilators include, but are not limited to, polycyclic aromatic hydrocarbons, e.g., anthracene, anthracene derivatives (e.g., diphenyl anthracene (DPA), 9,10-dimethylanthracene (DMA), 9,10-dipolyanthracene (DTA), 2-chloro-9,10-diphtylanthracene (DTACI), 2-carbonitrile-9,10-diptetrylanthracene (DTACN), 2-carbonitrile-9,10-dinaphthylanthracene (DNACN), 2-methyl-9,10-dinaphthylanthracene (DNAMe), 2-chloro-9,10-dinaphthylanthracene (DNACI), 9,10-bis (phenylethynyl) anthracene (BPEA), 2-chloro-9,10-bis (phenylethynyl) anthracene (2CBPEA), 5,6,11,12-tetraphenylnaphthacene(rubrene), pyrene and or perylene (e.g., tetra-t-butyl perylene (TTBP). The above anthracene derivatives may also be functionalized with a halogen. For example, DPA may be further functionalized with a halogen (e.g., fluorine, chlorine, bromine, iodine). Fluorescent organic dyes can be preferred.

A UC sensitizer can comprise at least one molecule capable of passing energy from a singlet state to a triplet state when it absorbs the photonic energy of excitation at the first wavelength. Examples of UC sensitizers include, but are not limited to, metalloporphyrins (e.g., palladium tetraphenyl tetrabutyl porphyrin (PdTPTBP), platinum octaethyl porphyrin (PtOEP), octaethyl-porphyrin palladium (PdOEP), palladium-tetratolylporphyrin (PdTPP), palladium-meso-tetraphenyltetrabenzoporphyrin 1 (PdPh4TBP), 1,4,8,11,15,18,22,25-octabutoxyphthalocyanine (PdPc (OBu)), 2,3-butanedione (or diacetyl), or a combination of several of the above molecules).

The UC sensitizer preferably absorbs the excitation at the first wavelength in order to make maximum use of the energy thereof.

A consideration in selecting a UC photosensitizer/annihilator pair may include the compatibility of the pair with the photoinitiator being used.

More preferably, at least a portion of the upconverting nanoparticles include a core portion that includes the UC sensitizer and annihilator in a liquid (e.g., oleic acid) and an encapsulating coating or a shell (e.g., silica) over at least a portion, and preferably substantially all, the outer surface of the core portion. The core can comprise a micelle, that includes the UC sensitizer and annihilator in a liquid. (A micelle is typically formed from one or more surfactants, e.g., having a relatively hydrophilic portion and a relatively hydrophobic portion.) Examples of preferred upconverting nanoparticles include nanocapsules described in International Application No. PCT/US2019/063629, of Congreve, et al., filed Nov. 27, 2019 which is hereby incorporated herein by reference in its entirety. Other information concerning nanocapsules that may be useful includes International Publication No. WO2015/059179, of Landfester, et al., which published Apr. 30, 2015 and S. Sanders, et al., “Photon Upconversion in Aqueous Nanodroplets”, J. Amer. Chem. Soc. 2019, 141, 9180-9184, each of which is hereby incorporated herein by reference in its entirety.

Upconverting nanoparticles can further include ligands at the surface thereof for facilitating distribution of the nanoparticles in the photopolymerization component. Surfactants and other materials useful as ligands are commercially available. Examples of ligands include, but are not limited to, poly-ethylene glycols.

A photoinitiator can be readily selected by one of ordinary skill in the art, taking into account its suitability for the mechanism to be used to initiate polymerization as well as its suitability for and/or compatibility with the resin to be polymerized. Information concerning photoinitiators that may be useful can be found in WO2019/025717 of Baldeck et al., published Feb. 7, 2019, and International Application No. Application No. PCT/US2019/063629, of Congreve, et al., filed Nov. 27, 2019, each of which is hereby incorporated herein by reference in its entirety.

A photopolymerizable liquid may further include additional additives. Examples of such additives include, but are not limited to, thixotropes, oxygen scavengers. WO2019/025717 of Baldeck et al., published Feb. 7, 2019 provides information that may be useful regarding additives.

Other information that may be useful with the present invention is U.S. Patent Application No. 62/911,125 of Congreve, et al., filed Oct. 4, 2019.

Examples of sources of the excitation light source for use in the methods and systems described herein include laser diodes, such as those available commercially, light emitting diodes, DMD projection systems, micro-LED arrays, vertical cavity lasers (VCLs). In some embodiments, the excitation radiation source (e.g., the light source) is a light-emitting diode (LED).

Systems and methods in accordance with the present invention are particularly useful for printing three-dimensional (3D) objects from photopolymerizable liquids that demonstrate non-Newtonian behavior and which can be solidified at volumetric positions impinged upon by excitation light to form a printed object without requiring the addition of support structures. Support structures are typically required by most 3D printing technologies involving vat polymerization technologies to stabilize the part during printing or to allow printing of thin or fragile overhanging portions of the part; after printing, post-processing is required to remove the support structures, which can damage or leave marks on the printed part. Avoiding addition of support structures would advantageously simplify post-processing of printed parts.

Systems and methods in accordance with the present invention are particularly useful for printing three-dimensional (3D) objects from photopolymerizable liquids that demonstrate non-Newtonian behavior and which can be solidified at volumetric positions impinged upon by excitation light to form a printed object which advantageously simplifies separation of the part from unpolymerized polymerizable liquid because upon application of stress, the apparent viscosity of the non-Newtonian photopolymerizable liquid drops to a lower value (e.g., the steady shear viscosity) than the static value (e.g., zero shear viscosity or yield stress) allowing the unpolymerized polymerizable liquid to more easily flow off and separate from the part.

Systems and methods in accordance with the present invention that include a photopolymerizable liquid that demonstrates non-Newtonian rheological behavior advantageously further do not require adhering the object being printed to a fixed substrate (e.g., build plate) at the beginning of the printing process avoiding a post-processing step of separating the printed object from the fixed substrate.

Post-processing steps of removing support structures and/or removing the printed object from a fixed substrate add labor (e.g., manual removal), waste (discarded support structures), and reduce throughput (a build plate cannot be reused until the printed object is removed), all of which add cost to the process.

Systems and methods in accordance with the present invention are additionally particularly useful for printing 3D objects from photopolymerizable liquids that demonstrate non-Newtonian behavior and which can be solidified at volumetric positions impinged upon by excitation light at a first wavelength by upconversion-induced photopolymerization. Preferably, the upconversion comprises triplet upconversion (or triplet-triplet annihilation, TTA) which may be used to produce light of a higher energy relative to light used to photoexcite the UC sensitizer or annihilator. Most preferably, the sensitizer absorbs low energy light and upconverts it by transferring energy to the annihilator, where two triplet excitons may combine to produce a higher energy singlet exciton that may emit high-frequency or shorter-wavelength light, e.g., via annihilation upconversion.

Methods and systems in accordance with the present invention are additionally particularly useful for printing 3D objects from photopolymerizable liquids that demonstrate non-Newtonian behavior and which can be solidified at volumetric positions impinged upon by excitation light at two different wavelengths by dual-color photopolymerization.

An example of another preferred the photopolymerizable liquid includes (i) a photopolymerizable component; and (ii) a dual-color photoinitiator (also referred to herein as a photoswitchable photoinitiator) that initiates polymerization of the photopolymerizable component upon simultaneous or sequential excitation by light at two different wavelengths, wherein the photopolymerizable liquid demonstrates non-Newtonian behavior.

As discussed herein, a photopolymerizable liquid can preferably include: a photopolymerizable component; a dual-color photoinitiator which converts from an inactive (non-initiating) form via excitation light of a first wavelength into an active (initiating) form, wherein subsequent or simultaneous excitation light of a second wavelength absorbed by the active form induces hardening or causes solidification of the photopolymerizable component; and optionally a synergist which in combination facilitates photoinitiation by the dual-color photoinitiator active form via, e.g., electron transfer or hydrogen transfer.

A dual-color photoinitiator or photoswitchable photoinitiator can comprise a photochromic dye. The dual-color photoinitiator preferably spontaneously reverts from active form to inactive form via thermal energy at the ambient temperature (T-type photochromism). Various types of T-type photochromic dyes are known to those skilled in the art, including but not limited to spiropyrans. These dyes function by light activated ring opening to form a merocyanine dye (active form). The active form may subsequently absorb light of a different wavelength to form an excited state of the active form which may subsequently induce photoinitiation, either alone or in combination with a coinitiator or synergist (e.g., amine, thiol, organoborate compounds). Properties important for the selection of a dual-color photoinitiator include absorbance spectra for the inactive and active forms; switching rates for the transitions between both forms; and equilibrium concentration of both forms; and intersystem crossing yield of the excited state of the active form. High intersystem crossing yield of the excited state of the active form is beneficial for producing long-lived triplet excited states which may interact via electron, hydrogen, or energy transfer with a syngerist to induce photoinitiation. A preferred example of a suitable dual-color photoinitiator is 1′-benzyl-3′,3′-dimethyl-8-iodo-7-methoxy-6-nitrobenzospiropyran. The conversion of a photochromic molecule to a second or active form of the molecule (e.g., an isomer thereof, e.g., for a photochromic molecule having a closed ring structure to a second from which is an open ring form thereof) is preferably a reversible photochemical structural change.

A coinitiator (also called a synergist) can comprise, e.g., an amine, a thiol, a thioether, a mercaptan, a silane, an organoborate compound, a diaryliodonium salt, a triarylsulfonium salt. A preferred example of a suitable synergist is butyryl choline butyltriphenylborate. A preferred example of a suitable coinitiator or synergist is N-methyldiethanolamine. (The terms coinitiator and synergist are used interchangeably herein.)

Optionally, a sensitizer for sensitizing the photoswitchable photoinitiator can be included in the photopolymerizable liquids that include a photoswitchable photoinitiator. Useful sensitizers include those known in the art such as acetophenone, benzophenone, 2-acetonaphthone, isopropyl thioxanthone, alkoxyketocoumarins, Esacure 3644, and the like.

Several considerations in selecting a photoswitchable photoinitiator include, by way of example, but not limited to, the absorption spectra and Amax of the photochromic molecule and its second forms, the solubility of the photoswitchable photoinitiator in the photohardenable component. the photosensitivity of the second form of the photoswitchable photoinitiator, the amount of initial concentration of the second form in the monomer solution, the stability of the photoswitchable photoinitiator and the reduction and oxidation potentials of the second form of the photoswitchable photoinitiator.

Examples of photohardenable components (also referred to herein as photopolymerizable components) useful in the present invention include ethylenically unsaturated compounds and, more specifically, a polyethylenically unsaturated compounds. These compounds include both monomers having one or more ethylenically unsaturated groups, such as vinyl or allyl groups, and polymers having terminal or pendant ethylenic unsaturation. Such compounds are well known in the art and include acrylic and methacrylic esters of polyhydric alcohols such as trimethylolpropane, pentaerythritol, and the like; and acrylate or methacrylate terminated epoxy resins, acrylate or methacrylate terminated polyesters, and the like. Representative examples include ethylene glycol diacrylate, ethylene glycol dimethacrylate, trimethylolpropane triacrylate (TMPTA), pentaerythritol tetraacrylate, pentaerythritol tetramethacrylate, dipentaerythritol hydroxypentacrylate (DPHPA), hexanediol-1,6-dimethacrylate, and diethyleneglycol dimethacrylate. Preferred examples include, but are not limited to, urethane acrylate or a urethane methacrylate.

The photopolymerizable liquid may further include one or more additives. Examples of such additives include, but are not limited to, thixotropes, oxygen scavengers.

Examples of sources of the excitation light source for use in the methods and systems described herein include laser diodes, such as those available commercially, light emitting diodes, DMD projection systems, micro-LED arrays, vertical cavity lasers (VCLs). In some embodiments, the excitation radiation source (e.g., the light source) is a light-emitting diode (LED).

Systems and methods in accordance with the present invention are particularly useful for printing three-dimensional (3D) objects from photopolymerizable liquids that demonstrate non-Newtonian behavior and which can be solidified at volumetric positions impinged upon by excitation light to form a printed object without requiring the addition of support structures. Support structures are typically required by most 3D printing technologies involving vat polymerization technologies to stabilize the part during printing or to allow printing of thin or fragile overhanging portions of the part; after printing, post-processing is required to remove the support structures, which can damage or leave marks on the printed part. Avoiding addition of support structures would advantageously simplify post-processing of printed parts.

Systems and methods in accordance with the present invention are particularly useful for printing three-dimensional (3D) objects from photopolymerizable liquids that demonstrate non-Newtonian behavior and which can be solidified at volumetric positions impinged upon by excitation light to form a printed object which advantageously simplifies separation of the part from unpolymerized polymerizable liquid because upon application of stress, the apparent viscosity of the non-Newtonian photopolymerizable liquid drops to a lower value (e.g., the steady shear viscosity) than the static value (e.g., zero shear viscosity or yield stress) allowing the unpolymerized polymerizable liquid to more easily flow off and separate from the part. Heating of the unpolymerized photopolymerizable liquid in addition to applying stress may further enhance the ability of the liquid to flow off and separate from the part.

As mentioned above, examples of such non-Newtonian rheological behavior include but are not limited to pseudoplastic fluid, yield pseudoplastic, Bingham pseudoplastic, or Bingham plastic.

Non-Newtonian rheological behavior can be imparted to a photopolymerizable composition by further including one or more reactive components (e.g. urethane acrylate oligomers, urethane methacrylate oligomers, acrylated or methacrylated polyurethanes, acrylated or methacrylated polyurethane-ureas, acrylated or methacrylated polyesters, acrylated or methacrylated polyamides, acrylate- or methacrylate-functional block copolymers, alkenyl- or alkynyl-functional urethane oligomers, alkenyl- or alkynyl-functional polyurethanes, alkenyl- or alkynyl-functional polyurethane-ureas, alkenyl- or alkynyl-functional polyesters, alkenyl- or alkynyl-functional polyamides, alkenyl- or alkynyl-functional block copolymers, thiol-functional urethane oligomers, thiol-functional polyurethanes, thiol-functional polyurethane-ureas, thiol-functional polyesters, thiol-functional polyamides, thiol-functional block copolymers) in the photohardenable component and/or by further adding one or more nonreactive additives (e.g., but not limited to, one or more thixotropes and/or rheology modifiers) to the photohardenable composition. Selection of the one or more of reactive components and the amounts thereof for addition to the photopolymerizable component to impart non-Newtonian rheological behavior thereto is within the skill of the skilled artisan in the relevant art without undue experimentation. Similarly, selection of nonreactive additives and the amount(s) thereof for addition to the photohardenable composition to impart non-Newtonian rheological behavior thereto is within the skill of the skilled artisan of the relevant art without undue experimentation.

For photopolymerizable liquids that demonstrate non-Newtonian rheological behavior discussed herein, preferred steady shear viscosities are less than 30,000 centipoise, more preferably less than 10,000 centipoise, and most preferably less than 1,000 centipoise. (Steady shear viscosity refers to the viscosity after the thixotrope network has broken up.) Steady shear viscosities may be measured at ambient (e.g., room temperature), printing temperature, or some other temperature (e.g., elevated or reduced). Measurement at printing temperature may provide advantage in determining the suitability of photopolymerizable liquid for printing.

Systems and methods in accordance with the present invention that include a photopolymerizable liquid that demonstrates non-Newtonian rheological behavior advantageously further do not require adhering the object being printed to a fixed substrate (e.g., build plate) at the beginning of the printing process avoiding a post-processing step of separating the printed object from the fixed substrate.

Post-processing steps of removing support structures and/or removing the printed object from a fixed substrate add labor (e.g., manual removal), waste (discarded support structures), and reduce throughput (a build plate cannot be reused until the printed object is removed), all of which add cost to the process.

The systems and methods in accordance with the present invention are additionally particularly useful for printing 3D objects from photopolymerizable liquids that demonstrate non-Newtonian behavior and which can be solidified at volumetric positions impinged upon sequentially or simultaneously by excitation light of two different wavelengths. Most preferably, the photopolymerizable liquid contains a dual-color photoinitiator which converts from an inactive form to an active form by excitation from the first wavelength and then is subsequently excited by the second wavelength which induces photoinitiation, either alone or through interaction with a synergist, and subsequent solidification of the photopolymerizable liquid.

It is desired that a photopolymerizable liquid including a dual-color photoinitiator does not harden (e.g., the photopolymerizable component does not undergo polymerization or cross-linking) upon exposure of the photopolymerizable liquid to only the first wavelength or only the second wavelength. In other words, hardening of the photopolymerizable liquid in the volume which is not simultaneously or nearly simultaneously (e.g., due to the closely timed sequential exposure) exposed to both radiations do not polymerize. In particular, in scanning a volume of the photohardenable media, as a result of beams passing through previously exposed areas or planes, there will be numerous points in the volume which are sequentially scanned in any order with the first wavelength radiation and the second wavelength radiation as the structure of the object is defined in the volume of the medium by the intersection of the beams. Some points may also experience multiple exposures to the first wavelength light and/or second wavelength light. It is desirable to select photoswitchable photoinitiators which rapidly reverse when they are not being exposed to first wavelength light.

Preferably the photopolymerizable liquid includes (i) a photopolymerizable component; (ii) a dual-color photoinitiator; and (iii) a coinitiator (also called a synergist). More preferably, the photopolymerizable liquid demonstrates non-Newtonian behavior.

The first and second wavelengths can be in the ultraviolet, visible, or near-infrared range. Preferably the first wavelength is in the ultraviolet range and the second wavelength is in the visible range.

Examples of photoswitchable photoinitiators useful in photopolymerizable liquids can absorb at about 300 nm to about 450 nm. Depending upon the absorption spectrum for the particular photoswitchable photoinitiator, the conversion to the second form can be induced by exposure to any source which emits in this range, e.g., lasers, light emitting diodes, mercury lamps. Filters may be used to limit the output wavelengths. A non-limiting example of filtered light includes filtered emission from a mercury arc lamp, and the like. The second form of the photoswitchable photoinitiator will preferably absorb in a range of about 450 nm to about 1000 nm and 450 nm to about 850 nm most typically.

Examples of power densities for the first wavelength light include power densities in a range from about 0.01 to about 100,000 W/cm² (inclusive). Examples of power densities for the second wavelength light include power densities in a range from about 0.01 to about 100,000 W/cm² (inclusive).

Examples of exposure energies for the first wavelength light include exposure energies in a range from about 0.001 to about 1,000 mJ/cm² (inclusive). Examples of exposure energies for the second wavelength light include exposure energies in a range from about 0.01 to about 100,000 mJ/cm² (inclusive).

Other information that may be useful in connection dual-wavelength photoinitiators and use thereof include U.S. Pat. No. 5,230,986 of Neckers, U.S. Pat. Nos. 4,041,476, 4,078,229, 4,238,840, 4,466,080, 4,471,470, and 4,333,165 to Swainson, U.S. Pat. No. 10,843,410 of Lippert, et al. for “System And Method For A Three-Dimensional Optical Switch Display (OSD) Device”, each of the foregoing being hereby incorporated herein by reference in its entirety.

An open, closable, or closed container for use in various aspects of the systems and methods of the present invention can be a one-piece unit or can be constructed from two (2) or more pieces.

A container can be constructed from a material comprising, for example, but not limited to, glass, quartz, fluoropolymers (e.g., Teflon FEP, Teflon AF, Teflon PFA), cyclic olefin copolymers, polymethyl methacrylate (PMMA), polynorbornene, sapphire, or transparent ceramic.

A channel of a closed container can be defined, for example, by the internal surfaces of the closed container.

Preferably the at least optically transparent portion(s) of the printing zone is (are) also optically flat.

Optionally, depending upon the oxygen sensitivity of the photopolymerizable liquid being used, the photopolymerizable liquid is purged or sparged with an inert gas before being introduced into the closed container and is maintained in an inert atmosphere while in the closed container. The source of the photopolymerizable liquid and the photopolymerizable liquid included in a reservoir used to feed the closed container is also optionally purged and maintained under inert conditions before use in the systems and methods of the present invention.

As shown in FIGS. 1-6, a container is depicted with an elongated shape. Such configuration facilitates a plurality of printed objects to be printed and moved out of the printing zone, one at a time, by pumping an amount of additional photopolymerizable liquid into the closed container to move the printed object out of the printing zone and introduce a new amount into the printing zone for printing a new object, with displaced contents being discharged from the exit port. After a series of printing parts and adding new photopolymerizable liquid into the printing zone, printed objects will eventually be included in discharged contents and collected after separation from the discharged contents. The separated objects can further be post-treated.

With an alternative design, the length of the channel in the closed container can correspond to the size of the printing zone, with the introduction of new photopolymerizable liquid filling the printing zone and discharging the printed object and unpolymerized photopolymerization liquid from the printing zone and exit port for separation. Other container designs and orientations may be desirable based on, for example, but not limited to, the number of printing zones and the type and number of optical systems selected.

The selected dimensions (e.g., height, width, footprint) of the system can also be a consideration for the size, shape, and orientation of the container and other components (e.g., regions, units, modules, and the like) included in the system.

A closed container channel can have a uniform cross-section over its length between the entry port and the exit port.

An open container or closable container can similarly have a uniform cross-section over its length from one end to the other

A closed container channel, closable container, or open container can alternatively have a non-uniform cross section. A non-uniform cross-section could be used to manipulate the spacing between successive printed objects, e.g., if the cross section gets larger the parts will move closer together; if the cross section gets smaller the parts will move farther apart. Either scenario could be potentially advantageous for object separation.

A channel or container can have a circular or oval cross-section. The channel can have a polygonal cross-section. The channel can have a rectangular or square cross-section. Other cross-section shapes may also be useful.

A channel or container can be an elongated tube with any of the above cross-sections or any other cross-sections that may be useful. Other shapes can also be useful.

A closed, open, or closable container can optionally further include a conveyor situated in the channel to assist in transporting the printed object to the exit port. A conveyor can be situated at the bottom of a container or at such other location in the system that is determined to be useful. It can be beneficial for the conveyor to include an antireflective coating on a side of the conveyor that may be impinged upon by the excitation light in the printing zone. Other coatings that could be included one surface of the conveyor (e.g., the surface transporting printed objects) or, optionally both the surface transporting printed objects and the opposite surface of the conveyor, include anti-corrosion or anti-marring coatings. Other coating materials include polymers such as polyolefins and fluoropolymers

The conveyor can comprise a belt conveyor, including by way of example, but not limited to, a solid belt, a mesh belt, a chain belt, and the like. The belt conveyor can likewise benefit from including an antireflective coating on a side of the belt that may be impinged upon by the excitation light in the printing zone. The conveyor can comprise a trolley or platform made of a magnetizable metal that can be actuated from outside the container using a magnetic field.

A pressure-exerting device for use in the systems and methods of the present invention preferably comprises a hydrostatic pump. A pressure-exerting device for use in the systems and methods of the present invention preferably comprises a peristaltic pump. Other suitable pumps or other pressure-exerting devices can be used.

The pressure-exerting device is preferably is capable of (i) pumping the photopolymerizable liquid from the source or reservoir into the container to fill the container with the photopolymerizable liquid and (ii) pumping an amount, which can be a metered amount, of the photopolymerizable liquid into the filled container to move printed object out of the printing zone in a direction toward the exit port, the exit port being adapted for discharging a portion of contents of the container displaced by the amount of the added photopolymerizable liquid through the exit port, out of the container. When a pressure-exerting device is used, the container is preferably a closed container or a closable container in its closed state.

Optionally the systems and methods of the present invention that include a pressure-exerting device can include two pressure-exerting devices wherein a first pump or other pressure exerting device is for moving the photopolymerizable liquid to the printing zone and a second pump or other pressure-exerting device imparts other flow characteristics to the photopolymerizable liquid. Inclusion of a second pressure-exerting device can be beneficial to compensate for a single pressure-exerting device's potential loss of effectiveness with distance.

In accordance with another aspect of the present invention, there is provided a method of separating one or more three-dimensional (3D) objects from a volume of a non-Newtonian photopolymerizable liquid, for example, in which the object is formed, the method comprising lowering the apparent viscosity (e.g., steady shear viscosity) of the non-Newtonian photopolymerizable liquid including the one or more 3D objects to a value below the static value (e.g., zero shear viscosity or yield stress) thereof such that unhardened photopolymerizable liquid flows off of or separates from the one or more objects.

Preferably lowering the apparent viscosity to a value below the static value comprises applying force or stress, e.g., by tapping, shaking, vibrating, sonicating, to the volume of the non-Newtonian photopolymerizable liquid including the one or more 3D objects.

More preferably the photopolymerizable liquid including the one or more 3D objects is heated at least a portion of the time force or stress is being applied to the volume of the non-Newtonian photopolymerizable liquid including the one or more 3D objects. The addition of heat can further enhance the ability of the liquid to flow off and/or separate from the part.

Optionally, methods described herein for printing or forming one or more 3D objects that include a photopolymerizable liquid that demonstrates non-Newtonian rheological behavior can further include a separation step comprising lowering the apparent viscosity (e.g., steady shear viscosity) of the non-Newtonian photopolymerizable liquid including the one or more 3D objects to a value below the static value (e.g., zero shear viscosity or yield stress) such that the unhardened photopolymerizable liquid flows off or separates from the one or more 3D objects. Preferably, heat can additionally be applied.

Embodiments of inventions described herein including the following:

Embodiment 1: A system for printing one or more three-dimensional objects, the system comprising: a container configured to contain a volume of a photopolymerizable liquid, the container including an exit port, the exit port facilitating discharge of photopolymerizable liquid and one or more of any printed three-dimensional objects contained therein from the container, the container including one or more printing zones, wherein a printing zone is configured to facilitate directing at least two excitation light projections into the printing zone to form a three-dimensional printed object within the volume of photopolymerizable liquid in the printing zone, and a dispensing system adapted for connection to a source of the photopolymerizable liquid for introducing an amount of the photopolymerizable liquid into the container.

Embodiment 2: The system of embodiment 1 wherein the container further includes an entry port positioned relative to the exit port to provide a flow path for photopolymerizable liquid from the entry port to the exit port that can facilitate transport of any printed part contained therein from the printing zone to the exit port for discharge from the container.

Embodiment 3: The system of embodiment 1 or 2 wherein the container comprises an open container.

Embodiment 4: The system of embodiment 1 or 2 wherein the container comprises a closed container.

Embodiment 5: The system of embodiment 1 or 2 wherein the system further comprises a gravity discharge mechanism or gravity drainage system in connection with the exit port for discharging photopolymerizable liquid and any printed objects contained therein out of the container.

Embodiment 6: The system of embodiment 1 or 2 wherein the system further comprises a separator unit in connection with the exit port of the container for receiving the unpolymerized photopolymerizable liquid and one or more printed three-dimensional objects discharged from the container.

Embodiment 7: The system of embodiment 6 wherein the separator unit is capable of separating any printed three-dimensional objects from unpolymerized photopolymerizable liquid included in the discharged contents.

Embodiment 8: The system of embodiment 6 or embodiment 7 wherein the separator unit includes a discharge port for discharging any separated printed objects from the separator unit.

Embodiment 9: The system of embodiment 8 wherein the separator unit further includes a second discharge port for discharging the separated unpolymerized photopolymerizable liquid from the separator unit.

Embodiment 10: The system of embodiment 6 further comprising a recycling unit in connection with the separator unit for receiving the separated unpolymerized photopolymerizable liquid for recycling.

Embodiment 11: The system of embodiment 9 wherein the system further includes a recirculation loop in connection with the second discharge port for recirculating the separated unpolymerized photopolymerizable liquid to the source.

Embodiment 12: The system of embodiment 10 wherein the system further includes a recirculation loop in connection with the recycling unit for recirculating the separated unpolymerized photopolymerizable liquid to the source.

Embodiment 13: The system of embodiment 10 wherein the recycling unit is configured to recondition the separated unpolymerized photopolymerizable liquid before recirculating it to the source.

Embodiment 14: The system of embodiment 1 or 2 wherein the dispensing system in connection with the entry port of the container is adapted for connection to a source of the photopolymerizable liquid, the dispensing system being capable of introducing an amount of the photopolymerizable liquid into the container through the entry port.

Embodiment 15: the system of embodiment 1 or 2 wherein the container has a uniform cross-section over its length dimension between the entry port and the exit port.

Embodiment 16: The system of embodiment 1 or 2 wherein the container is cylindrical having a circular or oval cross-section.

Embodiment 17: the system of embodiment 1 or 2 wherein the container has a polygonal cross-section.

Embodiment 18: the system of embodiment 1 or 2 wherein the container has a rectangular cross-section.

Embodiment 19: The system of embodiment 1 or 2 wherein the container is optically transparent.

Embodiment 20: The system of embodiment 1 or 2 wherein all sides (including the top side and bottom side) of the printing zone are optically transparent.

Embodiment 21: The system of embodiment 1 or 2 wherein one or more sides of the printing zone are optically transparent.

Embodiment 22: The system of embodiment 1 or 2 further comprising one or more optical systems positioned or positionable to selectively direct at least two excitation light projections through the one or more optically transparent regions of a printing zone.

Embodiment 23: The system of embodiment 1 or 2 wherein a single optical system is configured to project two excitation light projections into the printing zone.

Embodiment 24: The system of embodiment 22 wherein the system includes two or more optical systems positioned or positionable to selectively direct at least two excitation light projections through the one or more optically transparent regions of the printing zone.

Embodiment 25: The system of embodiment 1 or 2 wherein at least two excitation light projections include the same wavelength.

Embodiment 26: The system of embodiment 1 or 2 wherein at least two excitation light projections include different wavelengths.

Embodiment 27: A system for printing one or more three-dimensional objects, the system comprising: a closed container including an entry port and an exit port, the entry port and the exit port being connected by a channel therebetween, the closed container including one or more printing zones, wherein a printing zone comprises one or more optically transparent regions to facilitate directing at least two excitation light projections into the printing zone through the one or more optically transparent regions to form a three-dimensional printed object within a volume of photopolymerizable liquid in the printing zone, and a pressure-exerting device (e.g., a pump, a piston, or the like) in connection with the entry port of the closed container and adapted for connection to a source of the photopolymerizable liquid, the pressure-exerting device being capable of pumping an amount of the photopolymerizable liquid into the closed container through the entry port.

Embodiment 28: The system of embodiment 27 further comprising a separator unit in connection with the exit port of the closed container for receiving the discharged contents from the closed container and separating any printed objects from unpolymerized photopolymerizable liquid included in the discharged contents.

Embodiment 29: The system of embodiment 28 wherein the separator unit is capable of separating any printed three-dimensional objects from unpolymerized photopolymerizable liquid included in the discharged contents.

Embodiment 30: The system of embodiment 28 or 29 wherein the separator unit includes a discharge port for discharging any separated printed objects from the separator unit.

Embodiment 31: The system of embodiment 28 wherein the separator unit further includes a second discharge port for discharging the separated unpolymerized photopolymerizable liquid from the separator unit.

Embodiment 32: The system of embodiment 28 further comprising a recycling unit in connection with the separator unit for receiving and recycling the separated unpolymerized photopolymerizable liquid for recycling.

Embodiment 33: The system of embodiment 31 wherein the system further includes a recirculation loop in connection with the second discharge port for recirculating the separated unpolymerized photopolymerizable liquid to the source.

Embodiment 34: The system of embodiment 32 further comprising a recirculation loop in connection with the recycling unit for recirculating the separated unpolymerized photopolymerizable liquid to the source.

Embodiment 35: The system of embodiment 32 wherein the recycling unit is configured to recondition the separated unpolymerized photopolymerizable liquid before recirculating it to the source.

Embodiment 36: A system for printing one or more three-dimensional objects, the system comprising: a reservoir for containing a supply of a photopolymerizable liquid, the reservoir having a reservoir outlet and a reservoir inlet, a pressure-exerting device (e.g., a pump, a piston, or the like) in connection with the reservoir outlet for pumping an amount of the photopolymerizable liquid from the reservoir into a closed container through an entry port in the closed container, the closed container including an entry port and an exit port, the entry port and the exit port being connected by a channel therebetween, the closed container including one or more printing zones, wherein a printing zone comprises one or more optically transparent regions to facilitate directing at least two excitation light projections into the printing zone through the one or more optically transparent regions to form a three-dimensional printed object within a volume of photopolymerizable liquid in the printing zone, and a separator unit in connection with the exit port of the closed container for receiving output discharged from the closed container, the separator unit for separating any printed objects from unpolymerized photopolymerizable liquid included in the discharged contents.

Embodiment 37: The system of embodiment 36 wherein the separator unit includes a discharge port for discharging any separated printed objects from the separator unit.

Embodiment 38: The system of embodiment 37 wherein the separator unit further includes a second discharge port for discharging the separated unpolymerized photopolymerizable liquid from the separator unit.

Embodiment 39: The system of embodiment 36 further comprising a recycling unit in connection with the separator unit for receiving and recycling the separated unpolymerized photopolymerizable liquid for recycling.

Embodiment 40: The system of embodiment 38 wherein the system further includes a recirculation loop in connection with the second discharge port for recirculating the separated unpolymerized photopolymerizable liquid to the source.

Embodiment 41: The system of embodiment 39 wherein the system further includes a recirculation loop in connection with the recycling unit for recirculating the separated unpolymerized photopolymerizable liquid to the source.

Embodiment 42: The system of embodiment 39 wherein the recycling unit is configured to recondition the separated unpolymerized photopolymerizable liquid before recirculating it to the source.

Embodiment 43: The system of embodiment 27 or 36 wherein the system is capable of being maintained in an inert atmosphere and wherein each connection and port is airtight.

Embodiment 44: The system of embodiment 27 or 36 wherein the system is capable of being maintained in liquid tight state.

Embodiment 45: The system of embodiment 27 or 36 wherein the system is capable of being maintained in light tight state.

Embodiment 46: The system of embodiment 27 or 36 further comprising one or more optical system positioned or positionable to selectively direct at least two excitation light projections through the one or more optically transparent regions of a printing zone.

Embodiment 47: The system of embodiment 46 wherein a single optical system is configured to project two excitation light projections.

Embodiment 48: The system of embodiment 47 wherein the single optical system includes two light sources.

Embodiment 49: The system of embodiment 27 or 36 wherein the at least two excitation light projections include the same wavelength.

Embodiment 50: The system of embodiment 27 or 36 wherein the at least two of the at least two excitation light projections include at least two different wavelengths.

Embodiment 51: The system of embodiment 27 or 36 wherein the system includes two or more optical systems positioned or positionable to irradiate excitation light through the optically transparent window of the printing zone.

Embodiment 52: The system of embodiment 27 or 36 wherein the channel has a uniform cross-section over its length between the entry port and the exit port.

Embodiment 53: The system of embodiment 27 or 36 wherein the channel is cylindrical having a circular or oval cross-section.

Embodiment 54: The system of embodiment 27 or 36 wherein the channel has a polygonal cross-section.

Embodiment 55: The system of embodiment 27 or 36 wherein the channel has a rectangular or square cross-section.

Embodiment 56: The system of embodiment 27, 36, or 52 wherein the closed container is optically transparent.

Embodiment 57: The system of embodiment 27, 36, or 52 wherein all sides (including the top side and bottom side) of the printing zone are optically transparent.

Embodiment 58: The system of embodiment 27, 36, or 52 wherein one or more sides of the printing zone are optically transparent top and sides.

Embodiment 59: The system of embodiment 27 or 36 wherein the closed container further includes a conveyor situated at the bottom of the channel to assist in transporting the printed object to the exit port.

Embodiment 60: the system of embodiment 59 wherein the conveyor comprises an antireflective coating on a side of the conveyor that faces the entry point of the excitation light into the printing zone.

Embodiment 61: The system of embodiment 59 wherein the conveyor comprises a belt conveyor.

Embodiment 62: The system of embodiment 61 wherein the belt conveyor comprises a solid belt.

Embodiment 63: The system of embodiment 61 wherein the belt conveyor comprises a mesh belt.

Embodiment 64: The system of embodiment 61 wherein the belt conveyor comprises a chain conveyor.

Embodiment 65: The system of any one of embodiments 61,62, 63, and 64 wherein the belt conveyor comprises an antireflective coating on a side of the belt that may be impinged upon by the excitation light in the printing zone.

Embodiment 66: The system of embodiment 27 or 36 wherein the closed container is optically transparent.

Embodiment 67: The system of embodiment 27 or 36 wherein the closed container is removable or replaceable.

Embodiment 68: The system of embodiment 28 or 36 wherein the separator unit mechanically separates the one or more printed objects from the unpolymerized photopolymerizable liquid.

Embodiment 69: The system of embodiment 27 or 36 wherein the pressure-exerting device comprises a hydrostatic pump.

Embodiment 70: The system of embodiment 27 or 36 wherein the system includes two pressure-exerting devices wherein a first pressure-exerting device is for moving the photopolymerizable liquid to the printing zone and a second pressure-exerting device imparts other flow characteristics to the photopolymerizable liquid.

Embodiment 71: The system of embodiment 27 or 36 wherein the pressure-exerting device is capable of (i) pumping the photopolymerizable liquid into the closed container to fill the container with the photopolymerizable liquid and (ii) pumping a metered amount of the photopolymerizable liquid into the filled closed container to move printed object out of the printing zone in a direction toward the exit port, the exit port being adapted for discharging contents of the closed container displaced by the metered amount out of the closed container through the exit port.

Embodiment 72: A method of printing one or more three-dimensional objects, the method comprising: providing a volume of a photopolymerizable liquid in a container configured to contain a volume of a photopolymerizable liquid, the container including an exit port, the exit port facilitating discharge of photopolymerizable liquid and one or more of any printed three-dimensional objects contained therein from the container, the container including one or more printing zones, wherein a printing zone is configured to facilitate directing at least two excitation light projections into the printing zone to form a three-dimensional printed object within the volume of photopolymerizable liquid in the printing zone, directing the at least two excitation light projections into the printing zone to selectively photopolymerize the photopolymerizable liquid at one or more selected locations in the printing zone, and discharging the photopolymerizable liquid and any printed objects contained therein out of the container.

Embodiment 73: A method of printing one or more three-dimensional objects, the method comprising: providing a volume of a photopolymerizable liquid in a container including an entry port and an exit port, the entry port facilitating introduction of photopolymerizable liquid into the container and the exit port facilitating passage of unpolymerized photopolymerizable liquid and one or more printed three-dimensional object from the container, the container including one or more printing zones, wherein a printing zone is configured to facilitate directing at least two excitation light projections into the printing zone to form a three-dimensional printed object within a volume of photopolymerizable liquid in the printing zone, directing the at least two excitation light projections into the printing zone to selectively photopolymerize the photopolymerizable liquid in the printing zone, and discharging the photopolymerizable liquid and any printed objects contained therein out of the container.

Embodiment 74: The method of embodiment 72 or 73 wherein the container comprises an open container.

Embodiment 75: The method of embodiment 72 or 73 wherein the container comprises a closed container.

Embodiment 76: The method of embodiment 72 or 73 wherein the photopolymerizable liquid displays non-Newtonian rheological behavior and the at least two excitation light projections are selectively directed into the printing zone to selectively photopolymerize the photopolymerizable liquid at one or more selected locations in the printing zone to form a printed object without support structures.

Embodiment 77: The method of embodiment 76 wherein the printed object remains at a fixed position or is minimally displaced in the unpolymerized photopolymerizable liquid during formation.

Embodiment 78: The method of embodiment 72 wherein the exit port is controllably openable and closable.

Embodiment 79: The method of embodiment 73 wherein the entry port and exit port are controllably openable and closable.

Embodiment 80: The method of embodiment 72 or 73 wherein the container has a uniform cross-section over its length dimension.

Embodiment 81: The method of embodiment 72 or 73 wherein the container is cylindrical having a circular or oval cross-section.

Embodiment 82: The method of embodiment 72 or 73 wherein the container has a polygonal cross-section.

Embodiment 83: The method of embodiment 72 or 73 wherein the container has a rectangular or square cross-section.

Embodiment 84: The method of embodiment 72 or 73 wherein the container has a non-uniform cross-section over its length dimension.

Embodiment 85: The method of embodiment 72 or 73 wherein the container is optically transparent.

Embodiment 86: The method of embodiment 72 or 73 wherein all sides (including the top side and bottom side) of the printing zone are optically transparent.

Embodiment 87: The method of embodiment 72 or 73 wherein the container one or more sides of the printing zone are optically transparent top and sides.

Embodiment 88 includes a method of printing one or more three-dimensional objects, the method comprising: providing a volume of a photopolymerizable liquid in a closed container including an entry port and an exit port, the entry port and the exit port being connected by a channel therebetween, the container including at least one printing zone comprising one or more optically transparent regions to facilitate directing at least two excitation light projections into a printing zone through the one or more optically transparent regions, directing the at least two excitation light projections through the at least an optically transparent region into the printing zone to selectively photopolymerize the photopolymerizable liquid in the printing zone without support structures to form a printed object, wherein the printed object remains at a fixed position or is minimally displaced in the unpolymerized photopolymerizable liquid during formation, and applying pressure to the contents of the closed container and/or pumping additional photopolymerizable liquid into the closed container through the entry port to at least transport the printed object out of the printing zone toward the exit port, thereby discharging at least a portion of contents of the closed container out of the closed container through the exit port.

Embodiment 89: The method of embodiment 72, 73, or 88 wherein the method is carried out in an inert atmosphere.

Embodiment 90: The method of embodiment 72, 73, or 88 wherein the method is carried out in a non-inert atmosphere.

Embodiment 91: The method of embodiment 72, 73, or 88 further including separating any printed objects from unpolymerized photopolymerizable liquid included in the discharged contents.

Embodiment 92: The method of embodiment 91 further comprising recirculating the discharged unpolymerized photopolymerizable liquid after separation of any printed objects to a reservoir.

Embodiment 93: The method of embodiment 77 or 88 wherein minimally displaced comprises displacing the printed object by an amount that is acceptable for precisely reproducing the geometry of the object to be printed during time intervals required to form the object.

Embodiment 94: The method of embodiment 72, 73, or 88 wherein the at least two excitation light projections are selectively directed into the printing zone to selectively photopolymerize the photopolymerizable liquid at one or more selected locations in the printing zone to form a printed object without support structures.

Embodiment 95: The method of embodiment 88 wherein the entry port and exit port are controllably openable and closable.

Embodiment 96: The method of embodiment 88 wherein the photopolymerizable liquid displays non-Newtonian rheological behavior such that the object formed in the photopolymerizable liquid within the printing zone remains at a fixed position or is minimally displaced in the unpolymerized photopolymerizable liquid during formation.

Embodiment 97: The method of embodiment 88 wherein the channel has a uniform cross-section over its length dimension between the entry port and the exit port.

Embodiment 98: The method of embodiment 88 wherein the channel is cylindrical having a circular or oval cross-section.

Embodiment 99: The method of embodiment 88 wherein the channel has a polygonal cross-section.

Embodiment 100: The method of embodiment 88 wherein the channel has a rectangular or square cross-section.

Embodiment 101: The method embodiment 88 wherein the channel is defined by the internal surfaces of the closed container.

Embodiment 102: The method of embodiment 88 wherein the container has a non-uniform cross-section over its length dimension.

Embodiment 103: The method of embodiment 88 wherein the closed container is optically transparent.

Embodiment 104: The method of embodiment 88 or 96 wherein all sides (including the top side and bottom side) of the printing zone are optically transparent.

Embodiment 105: The method of embodiment 88 wherein one or more sides (including the top side and bottom side) of the printing zone are optically transparent.

Embodiment 106: The system of embodiment 1, 27 or 36 wherein the cross-section of the channel is non-uniform.

Embodiment 107: The system of embodiment 1, 27, or 36 wherein an optical system is in connection with one or more excitation light source.

Embodiment 108: The system of embodiment 1, 27, or 36 wherein each excitation light projection is generated by a separate optical system in connection with an excitation light source.

Embodiment 109: The system of embodiment 108 wherein two excitation light projections are generated by separate optical systems in connection excitation light sources emitting different wavelengths.

Embodiment 110: The system of embodiment 109 wherein at least one of the optical systems comprises a digital micromirror display projection system.

Embodiment 111: A system for printing one or more three-dimensional objects, the system comprising: a container including an entry port and an exit port, the entry port and the exit port being connected by a flow path therebetween, the container including a printing zone, wherein the printing zone comprises at least one optically transparent region to facilitate directing an excitation light into the printing zone through the optically transparent region to form a three-dimensional printed object within a volume of photopolymerizable liquid in the printing zone, and a pressure-exerting device (e.g., a pump, a piston, or the like) in connection with the entry port of the container and adapted for connection to a source of the photopolymerizable liquid, the pressure-exerting device being capable of pumping an amount of the photopolymerizable liquid into the container through the entry port.

Embodiment 112: The system of embodiment 111 further comprising a separator unit in connection with the exit port of the container for receiving the discharged contents from the container, the separator unit for separating any printed objects from unpolymerized photopolymerizable liquid included in the discharged contents, the separator unit including a first discharge port for discharging any separated printed objects from the separator unit and a second discharge port for discharging the separated unpolymerized photopolymerizable liquid from the separator unit.

Embodiment 113: The system of embodiment 111 further comprising a recirculation loop in connection with the second discharge port for recirculating the separated unpolymerized photopolymerizable liquid to the source.

Embodiment 114: The system of embodiment 111 further comprising a reservoir for containing a supply of a photopolymerizable liquid, the reservoir having a reservoir outlet and a reservoir inlet.

Embodiment 115: The system of embodiment 111 further comprising one or more optical systems positioned or positionable to irradiate excitation light through the optically transparent window of a printing zone.

Embodiment 116: A method of printing one or more three-dimensional objects, the method comprising: providing a volume of a photopolymerizable liquid in a container including an entry port and an exit port, the entry port and the exit port being connected by a flow path therebetween, the container including at least one printing zone comprising at least an optically transparent window to facilitate irradiating excitation light at a first wavelength into a printing zone through the at least an optically transparent window, directing the excitation light through the at least an optically transparent window into the printing zone to selectively photopolymerize the photopolymerizable liquid in the printing zone without support structures to form a printed object, wherein the printed object remains at a fixed position or is minimally displaced in the unpolymerized photopolymerizable liquid during formation, and applying pressure to the contents of the container and/or pumping additional photopolymerizable liquid into the container through the entry port to at least transport the printed object out of the printing zone toward the exit port, thereby discharging at least a portion of contents of the container out of the container through the exit port.

Embodiment 117: The method of embodiment 116 further comprising separating any printed objects from unpolymerized photopolymerizable liquid included in the discharged contents.

Embodiment 118: The method of embodiment 116 further comprising recirculating the discharged unpolymerized photopolymerizable liquid after separation of any printed objects to a reservoir.

Embodiment 119: The method of embodiment 116 wherein the photopolymerizable liquid displays non-Newtonian rheological behavior such that the object formed in the photopolymerizable liquid within the printing zone remains at a fixed position or is minimally displaced in the unpolymerized photopolymerizable liquid during formation, directing the excitation light through the at least an optically transparent window into the printing zone to selectively photopolymerize the photopolymerizable liquid in the printing zone without support structures to form a printed object, wherein the printed object remains at a fixed position or is minimally displaced in the unpolymerized photopolymerizable liquid during formation.

Embodiment 120: The method of any one of embodiments 72, 73, 88, and 116 wherein the photopolymerizable liquid comprises a photohardenable component and a photoswitchable photoinitiator, wherein the photoswitchable photoinitiator is activatable by exposure to light having a first wavelength and light having a second wavelength to induce a crosslinking or polymerization reaction in the photohardenable component, wherein the first and second wavelengths are different, and wherein the photopolymerizable composition displays non-Newtonian rheological behavior.

Embodiment 121: The system of any one of embodiments 1, 27, 36, and 111 wherein the photopolymerizable liquid comprises a photohardenable component and a photoswitchable photoinitiator, wherein the photoswitchable photoinitiator is activatable by exposure to light having a first wavelength and light having a second wavelength to induce a crosslinking or polymerization reaction in the photohardenable component, wherein the first and second wavelengths are different, and wherein the photopolymerizable composition displays non-Newtonian rheological behavior.

Embodiment 122: The method of embodiment 120 or system of embodiment 121 wherein the photopolymerizable liquid further includes a coinitiator.

Embodiment 123: The method of embodiment 120 or system of embodiment 121 or embodiment 122 wherein the photopolymerizable liquid further includes a sensitizer.

Embodiment 124: The system of embodiment 120 or 121 or 122 wherein the photopolymerizable liquid further includes a synergist.

Embodiment 125: The system of embodiment 120 or 121 optionally further including at least one of a coinitiator, a synergist, and a sensitizer.

Embodiment 126: The system of any one of embodiments 1, 27, 36, and 111 wherein one or more components of the system are modular.

Embodiment 127: The system of any one of embodiments 1, 27, 36, 111, and 126 wherein one or more components of the system are replaceable.

Embodiment 128: The system of any one of embodiments 1, 27, 36, and 111 wherein one or more components of the system are included in a single housing.

Embodiment 129: The system of any one of embodiments 6, 28, 36, and 111 further comprising a post-treatment unit or region.

Embodiment 130: The system of any one of embodiments 1, 27, 36, and 111 further comprising one or more inspection units or regions for inspecting printed objects after formation.

Embodiment 131: The method of any one of embodiments 72, 73, 88, and 116 further comprising post-treating printed parts after separation from unpolymerized photopolymerizable liquid.

Embodiment 132: The method of any one of embodiments 72, 73, 88, and 116 further comprising inspecting printed parts after formation.

Other information that may be useful in connection with the present invention includes International Patent Application No. PCT/US2021/035791 of Quadratic 3D, Inc. filed Jun. 3, 2021 for “Volumetric Three-Dimensional Printing Methods Including A Light Sheet And Systems” and U.S. Patent Application No. 63/223,112 of Quadratic 3D, Inc. filed Jul. 19, 2021, and International Application No. PCT/US2021/024878 of Quadratic 3D, Inc. filed Mar. 30, 2021, each of the foregoing being hereby incorporated herein by reference in its entirety.

The systems and methods of the present invention may be useful with other 3D printing techniques that include initiation of a photochemical reaction in a photoreactive system via the absorption of light energy supplied by one or more excitation light projections to form an object. Examples include tomographic printing, two-photon printing, upconversion printing, and dual-wavelength printing.

Before printing, a digital file of the object to be printed is obtained. If the digital file is not of a format that can be used to print the object, the digital file is then converted to a format that can be used to print the object. An example of a typical format that can be used for printing is an STL file. Typically, the STL file is then sliced into two-dimensional layers with use of three-dimensional slicer software and converted into G-Code or a set of machine commands, which facilitates building the object. See B. Redwood, et al., “The 3D Printing Handbook—Technologies, designs applications”, 3D HUBS B. V. 2018.

When used as a characteristics of a portion of a container or build chamber, “optically transparent” refers to having high optical transmission to the wavelength of light being used, and “optically flat” refers to being non-distorting (e.g., optical wavefronts entering the portion of the container or build chamber remain largely unaffected).

As used herein, the singular forms “a”, “an” and “the” include plural unless the context clearly dictates otherwise. Thus, for example, reference to an emissive material includes reference to one or more of such materials.

Applicant specifically incorporates the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

1-33. (canceled)

34. A method of printing one or more three-dimensional objects, the method comprising:
providing a volume of a photopolymerizable liquid in a container configured to contain a volume of a photopolymerizable liquid, the container including an exit port, the exit port facilitating discharge of photopolymerizable liquid and one or more of any printed three-dimensional objects contained therein from the container, the container including one or more printing zones, wherein a printing zone is configured to facilitate directing at least two excitation light projections into the printing zone to form a three-dimensional printed object within the volume of photopolymerizable liquid in the printing zone, wherein the photopolymerizable liquid comprises a photohardenable component and a photoswitchable photoinitiator, wherein the photoswitchable photoinitiator is activatable by exposure to a first excitation light including a first wavelength and light having a second excitation light including second wavelength to induce a crosslinking or polymerization reaction in the photohardenable component, wherein the first and second wavelengths are different, and wherein the photopolymerizable composition displays non-Newtonian rheological behavior,
directing the at least two excitation light projections into the printing zone to selectively photopolymerize the photopolymerizable liquid at one or more selected locations in the printing zone, and
discharging the photopolymerizable liquid and any printed objects contained therein out of the container.

35-37. (canceled)

38. The method of claim 34 wherein the at least two excitation light projections are selectively directed into the printing zone to selectively photopolymerize the photopolymerizable liquid at one or more selected locations in the printing zone to form a printed object without support structures.

39. The method of claim 38 wherein the printed object remains at a fixed position or is minimally displaced in the unpolymerized photopolymerizable liquid during formation.

40. (canceled)

41. The method of claim 34 further including separating any printed objects from unpolymerized photopolymerizable liquid included in the discharged contents.

42. The method of claim 41 further comprising recirculating the discharged unpolymerized photopolymerizable liquid after separation of any printed objects to a reservoir.

43. The method of claim 39 wherein minimally displaced comprises displacing the printed object by an amount that is acceptable for precisely reproducing the geometry of the object to be printed during time intervals required to form the object.

44-54. (canceled)

55. A method of printing one or more three-dimensional objects, the method comprising:
providing a volume of a photopolymerizable liquid in a container including an entry port and an exit port, the entry port and the exit port being connected by a flow path therebetween, the container including at least one printing zone comprising at least an optically transparent window to facilitate directing at least two excitation light projections into the printing zone through the at least an optically transparent window, wherein the photopolymerizable liquid comprises a photohardenable component and a photoswitchable photoinitiator, wherein the photoswitchable photoinitiator is activatable by exposure to a first excitation light including a first wavelength and light having a second excitation light including second wavelength to induce a crosslinking or polymerization reaction in the photohardenable component, wherein the first and second wavelengths are different, and wherein the photopolymerizable composition displays non-Newtonian rheological behavior,
directing the at least two excitation light projections through the at least one optically transparent window into the printing zone to selectively photopolymerize the photopolymerizable liquid in the printing zone without support structures to form a printed object, wherein the printed object remains at a fixed position or is minimally displaced in the unpolymerized photopolymerizable liquid during formation, and
applying pressure to the contents of the container and/or pumping additional photopolymerizable liquid into the container through the entry port to at least transport the printed object out of the printing zone toward the exit port, thereby discharging at least a portion of contents of the container out of the container through the exit port.

56. The method of claim 55 further comprising separating any printed objects from unpolymerized photopolymerizable liquid included in the discharged contents.

57. The method of claim 55 further comprising recirculating the discharged unpolymerized photopolymerizable liquid after separation of any printed objects to a reservoir.

58-59. (canceled)

60. The method of claim 55 wherein the photopolymerizable liquid further includes a coinitiator.

61-70. (canceled)

71. The method of claim 34 further comprising post-treating printed parts after separation from unpolymerized photopolymerizable liquid.

72. The method of claim 34 further comprising inspecting printed parts after formation.

73. A method of separating one or more three-dimensional (3D) objects from a volume of a non-Newtonian photopolymerizable liquid, the method comprising lowering the apparent viscosity (e.g., steady shear viscosity) of the non-Newtonian photopolymerizable liquid including the one or more 3D objects to a value below the static value (e.g., zero shear viscosity or yield stress) thereof such that unhardened photopolymerizable liquid flows off of or separates from the one or more objects, and applying heat at least a portion of the time force or stress is being applied.

74. The method of claim 73 wherein lowering the apparent viscosity of the non-Newtonian photopolymerizable liquid to a value below the static value thereof comprises applying force or stress to the volume of the non-Newtonian photopolymerizable liquid including the one or more 3D objects such that unhardened photopolymerizable liquid can flow off of or separate from the object.

75-76.(canceled)

77. The method of claim 34 wherein the photopolymerizable liquid further includes a coinitiator.

78. The method of claim 55 further comprising post-treating printed parts after separation from unpolymerized photopolymerizable liquid.

79. The method of claim 55 further comprising inspecting printed parts after formation.

80. The method of claim 34 further including a separation step comprising lowering the apparent viscosity of the non-Newtonian photopolymerizable liquid including the one or more 3D objects to a value below the static value such that the unhardened photopolymerizable liquid flows off or separates from the one or more 3D objects.

81. the method of claim 80 wherein the separation step further comprises applying heat at least a portion of the time force or stress is being applied.

82. The method of claim 55 further including a separation step comprising lowering the apparent viscosity of the non-Newtonian photopolymerizable liquid including the one or more 3D objects to a value below the static value such that the unhardened photopolymerizable liquid flows off or separates from the one or more 3D objects.

83. the method of claim 82 wherein the separation step further comprises applying heat at least a portion of the time force or stress is being applied.
